(19) United States
(12) Patent Application Publication
(10) Pub. No.: US 2025/0073774 A1
(43) Pub. Date: Mar. 6, 2025

(54) Hydraulic Forming Machine for Workpiece Forming, Hydraulic Control Unit and Method for Controlling a Hydraulic Cylinder of a Hydraulic Forming Machine

(71) Applicant: Langenstein & Schemann GmbH, Coburg (DE)

(72) Inventors: Markus Otto, Lautertal (DE); Harald Barnickel, Coburg (DE)

(21) Appl. No.: 18/671,770

(22) Filed: May 22, 2024

(30) Foreign Application Priority Data
May 23, 2023 (DE) 102023113473.6

(51) Int. Cl. B21J 7/28; B21J 7/46; B21J 9/12

(52) U.S. Cl. CPC B21J 7/28; B21J 7/46; B21J 9/12

(57) ABSTRACT

A hydraulic forming machine, includes a hydraulic cylinder with a piston guided in a cylinder tube and divides the cylinder tube into a first cylinder chamber, and a second cylinder chamber. A hydraulic circuit with a control unit for controlling the operation of the hydraulic cylinder includes a first hydraulic valve coupled to the control unit and is connected to the second cylinder chamber via the second hydraulic connection. The control unit regulates an opening width of the first hydraulic valve such that the first hydraulic valve is open in a first phase and the bear) is accelerated to a target speed in the first phase, while, in a following second phase the opening width of the first hydraulic valve is reduced to an inflow opening width, and the first hydraulic valve is closed during a return stroke running in the opposite direction to the working stroke.

The underlying invention relates to a hydraulic forming machine for workpiece forming, a hydraulic control unit and a method for controlling a hydraulic cylinder of a hydraulic forming machine.

Various forming machines are known for pressing or forming workpieces in cold forming, in particular in sheet metal forming, or in hot forming, in particular in the forging of metallic, forgeable materials (see, for example, VDI-Lexikon Band Produktionstechnik Verfahrenstechnik, publisher: Hiersig, VDI-Verlag, 1995, pages 1107 to 1113). At least one ram or bear with an upper forming tool of the forming machine is driven by a drive and moved relative to a lower forming tool of the forming machine, so that the workpiece can be formed by forming forces between the forming tools.

Known hydraulic forming machines use a hydraulic drive by means of a hydraulic medium or hydraulic fluid, such as oil or water, whose pressure energy is first converted into kinetic energy of motion and finally, during the forming process, into mechanical forming work by pistons running in hydraulic cylinders, especially in the forging hammer. The hydraulic drive of the piston can be a pump drive with a pump and an electrically controllable pump motor (see e. g. DE 196 80 008 C1) or also a hydraulic accumulator drive with a pressure accumulator and motor-driven pump to create the pressure in the pressure accumulator (see e. g. WO 2013/167610 A1).

DE 10 2015 105 400 A1 discloses a forging hammer with an impact tool that is coupled to a hydraulic differential cylinder to perform a working stroke from top to bottom or a return stroke from bottom to top. A hydraulic pump is provided to drive the differential cylinder, which pump is connected to the cylinder chambers of the differential cylinder via a directional single control valve.

DE 10 2014 002 888 B4 discloses a forging hammer comprising a hydraulic cylinder with a bear coupled thereto for workpiece forming. The hydraulic cylinder comprises an upper, a middle and a lower hydraulic connection. During a working stroke, a stroke chamber of the hydraulic cylinder assigned to the working stroke is fed with hydraulic fluid via the upper hydraulic connection. During a return stroke, the upper hydraulic connection is closed and the hydraulic fluid displaced from the stroke chamber is fed into a return tank via the middle connection. The forging hammer is operated in such a way that the upper hydraulic connection is closed during the return stroke and the piston of the hydraulic cylinder is braked by the hydraulic fluid remaining in the hydraulic cylinder when it passes over the middle hydraulic connection. A disadvantage of the known forging hammer is its complex design with four hydraulic connections, and also the fact that an upper dead center, which serves as the starting point for triggering a forging stroke, is firmly linked to the position of the middle hydraulic connection.

There is still potential to simplify the design of known forming machines, especially forging hammers, to ensure safe operation of the hydraulic circuit and to improve the movement sequences of the bear or the associated tools, for example with regard to the adjustability of the target speed of the bear for forming, with regard to the reproducibility of the movement of the bear and/or with regard to safe operation, e. g. in the event of failure of the control electronics.

In this respect, an object of the invention is to provide a new or improved hydraulic forming machine, in particular a forging hammer.

In particular, such a forming machine shall be provided which is comparatively simple in design, which enables improved movement control and/or regulation of the bear with coupled impact tool for forming, and/or which enables movement control with increased safety and/or reduced or decreased cavitation formation in the hydraulic medium or hydraulic fluid. Furthermore, a hydraulic control unit for operating a hydraulic forming machine and a method for operating a hydraulic cylinder of a hydraulic forming machine, in particular a forging hammer, shall be provided.

This object is solved by the features of the independent claims. Embodiments result in particular from the dependent claims and from the following description of exemplary implementations and embodiments.

According to one embodiment, a hydraulic forming machine, in particular an impact forming machine, preferably a forging hammer, is provided for workpiece forming or forming of a workpiece. The forming machine comprises a hydraulic cylinder with a piston guided in a cylinder tube.

The piston divides the cylinder tube into a first cylinder chamber through which a piston rod coupled to a bear passes and which is designed as an annular chamber due to the piston rod passing through it, and into a second cylinder chamber, which is arranged on the side of the piston facing away from the first cylinder chamber and is also referred to as the piston chamber. The first cylinder chamber has a first hydraulic connection and the second cylinder chamber has a second hydraulic connection. When the hydraulic cylinder is arranged vertically, the first hydraulic connection may be referred to as a lower connection and the second hydraulic connection may be referred to as an upper connection. Accordingly, the first cylinder chamber can be referred to as a lower cylinder chamber and the second cylinder chamber can be referred to as an upper cylinder chamber.

The hydraulic forming machine further comprises a hydraulic circuit comprising at least one control unit, also referred to herein as a hydraulic control unit. The control unit is set up to control and/or regulate the operation of the hydraulic cylinder. In addition to the control unit, other components can be added to the hydraulic circuit, such as hydraulic lines, pressure sensors, etc.

The hydraulic cylinder is connected to the hydraulic circuit via the first and second hydraulic connections, or the hydraulic circuit is connected to the hydraulic cylinder via the first and second hydraulic connections.

The hydraulic circuit comprises a first hydraulic valve coupled, in terms of control technology, to the control unit. The first hydraulic valve is preferably designed as a proportional valve.

The first hydraulic valve is connected to the second cylinder chamber via the second hydraulic connection.

If the hydraulic cylinder is arranged vertically and the bear is arranged below the hydraulic cylinder, pressurizing the second cylinder chamber causes a working stroke to be executed—in the case of a forging hammer, the execution of a forging blow or impact. In this respect, the first hydraulic valve can be described as an “impact valve”.

A working stroke is to be understood as an operation or an operating phase of the hydraulic cylinder, in which the second cylinder chamber is pressurized with hydraulic fluid and the bear can be moved away from the cylinder tube towards a workpiece for its forming. Such a working stroke is also referred to as a blow or forming stroke in the operation of a forming machine designed as a forging hammer. A movement opposite to the working stroke is referred to as a return stroke. A complete working cycle of the hydraulic cylinder can thus be understood as a sequence of movement cycles consisting of working stroke and return stroke.

According to one aspect of the invention, the control unit is arranged to regulate and/or control an opening width of the first hydraulic valve when performing a working stroke intended for forming a workpiece such that
the first hydraulic valve is opened in a first phase of the working stroke and the bear is accelerated to a target speed in the first phase,
in a second phase of the working stroke following the first phase, in particular after reaching the target speed, the opening width of the first hydraulic valve is reduced or decreased to an inflow opening width, and
the first hydraulic valve is closed during a return stroke that runs in the opposite direction to the working stroke.

It is particularly advantageous to set the inflow opening width in such a way that the hydraulic pressure in the hydraulic system is above the cavitation pressure. In particular, the control unit can be set up so that the hydraulic pressure in the second cylinder chamber is above 3 bar, but at least above 1 bar. As air is only released from hydraulic oil at 1 bar, for example, harmful cavitation can be avoided or prevented.

Preferably, the control unit is set up in such a way that it adjusts the inflow opening width according to a predetermined or predeterminable opening width.

The hydraulic valve is particularly advantageous implemented as a proportional valve, especially as a so-called cartridge valve.

In particular, it is provided and the control unit is set up accordingly that in the second phase, the first hydraulic valve is not completely closed, but that the opening width is closed down to a remaining opening gap, for example a minimum opening gap. Hydraulic fluid can inflow into the second cylinder chamber via the remaining opening gap, in particular in such a way that the bear is not further accelerated by the hydraulic fluid, so that the bear essentially maintains the reached target speed. The term “inflow” is to be understood in particular as an essentially pressureless filling of the second cylinder chamber with hydraulic fluid, in particular in such a way that the bear or piston is not further accelerated by the hydraulic fluid flowing in or by hydraulic liquid flowing in, and the reached target speed is at least essentially maintained or can be maintained. In particular or alternatively, “inflow” shall mean that there is approximately 3 bar at the hydraulic cylinder or that the pressure does not fall below at least 1 bar—so that cavitations in the hydraulic fluid, in particular a hydraulic oil, can be avoided.

The system pressure of the hydraulic circuit, which, in particular, is applied to the first hydraulic connection, is preferably around 200 bar, e. g. in the range between 190 and 210 bar, or between 197 bar and 203 bar.

During a working stroke of the hydraulic cylinder for forming a workpiece, the bear continues to move after reaching the target speed, whereby the volume of the second cylinder chamber increases and is filled accordingly with hydraulic fluid or hydraulic fluid, i. e. with the inlow hydraulic fluid. This filling or inflow is achieved by setting the first hydraulic valve to the inflow opening width. The inflow opening width can, for example, be between 3 and 20%, preferably between 5 and 15% or 10 and 15% of the opening width of the hydraulic valve.

The overall result for the proposed forming machine is a comparatively simple, precise and reproducible control and/or regulation of the hydraulic cylinder for executing a working stroke for forming a workpiece.

According to embodiments, the hydraulic circuit further comprises a second hydraulic valve, which is connected to the second hydraulic connection, whereby the control unit is set up to control an opening width of the second hydraulic valve, which is preferably designed as a proportional valve, in such a way that an initial position of the bear for a subsequent working stroke can be variably adjusted when a return stroke is performed in the opposite direction to the working stroke. In the case of a vertically arranged hydraulic cylinder, in which the working stroke is downwards, the second hydraulic valve can also be referred to as a “lifting valve”. Consequently, in a corresponding forming machine with a vertical structure, the first hydraulic valve can be referred to as an impact valve and the second hydraulic valve as a lifting valve.

By using proportional valves, comparatively precise control of the bear's movement can be achieved. In particular, advantageous and precise control of the speed of the bear can be achieved. Furthermore, it is comparatively easy to control and/or regulate the movement of the bear, for example to different, respectively desired target speeds and/or to different and/or varying starting positions for executing a working stroke or blow.

According to embodiments, the forming machine may further comprise a measuring unit for determining the position and/or speed of the bear. The control unit can be set up to determine one or more operating parameters, e. g. for a subsequent, in particular immediately subsequent working stroke, on the basis of a forming position determined by the measuring unit for a preceding working stroke and/or other operating parameters detected. The following are particularly suitable operating parameters: initial position for executing a working stroke, a target speed reached after the first phase, an impact energy of the bear for workpiece forming, a position of the bear, in particular the forming position of the bear. The forming position of the bear is to be understood in particular as the position of the bear at which the forming of the workpiece takes place or begins during a working stroke. Advantageously, the control unit is set up to determine the operating parameter or parameters for a subsequent working stroke, i. e. for a further working stroke immediately following a working stroke, for example.

In advantageous embodiments, the control unit can be set up to perform an initial working stroke as a set-stroke executed at minimum impact energy during a forming operation of a workpiece. With such a set-stroke, it is possible, in particular, to determine the forming position, i. e. the position of the bear at which it hits the workpiece to be formed or the position of the side of the workpiece facing the bear.

If the control unit is also set up to determine not only the forming position of the bear but also the starting position of the bear for executing a working stroke or if the starting position is available, the stroke range available for a working stroke between the starting position and the forming position, and thus the respective range required or the available path length for accelerating the bear, can be determined and used to set operating parameters for accelerating the bear to the target speed. A corresponding operating parameter can be the opening width of the first hydraulic valve or the opening width of the first hydraulic cylinder over time.

According to embodiments, it is also possible that the operating parameters determined, such as the starting position, forming position, impact energy, etc., are used to control and/or regulate the second hydraulic valve during a return stroke. For example, the control unit can be set up to use corresponding operating parameters, such as the starting position for a subsequent working stroke, to control the second hydraulic valve during the return stroke. According to embodiments, the control unit can in particular be set up to control and/or regulate the opening width of the second hydraulic valve or to control and/or regulate the closing behavior of the second hydraulic valve in such a way that the bear reaches the desired starting position for the next working stroke during the return stroke.

With the proposed control unit and the hydraulic valves, in particular with proportional valves, it is possible, in particular, to dynamically adjust the starting position for executing a working stroke, for example in such a way that working strokes can be executed from different starting positions. This enables comparatively flexible operating cycles and forming operations with simultaneously precise and reliable adjustment of the forming parameters.

According to embodiments, the control unit can be set up to control the opening width of the first hydraulic valve on the basis of a variably predeterminable and/or determinable starting position and/or a variable forming position (or: reversal position, rest position), in particular a variably predeterminable and/or determinable forming position, in particular in such a way that the working stroke, in particular a forming stroke, can be executed with a suitable, preferably predetermined, in particular a maximum available impact energy in each case.

According to embodiments, the control unit can be set up to variably or dynamically variably set an initial position for executing a working stroke, in particular as a function of at least one operating parameter of the hydraulic cylinder with respect to one or more preceding working strokes, the operating parameter preferably being an operating parameter detected by one or more sensor units. For example, the forming position during a preceding working stroke when forming a workpiece with several strokes can be used to set the starting position for a subsequent working stroke for the workpiece and/or to set the opening width for accelerating the bear during the subsequent working stroke, for example in accordance with a predetermined or desired forming energy and/or target speed.

According to embodiments, the control unit can be set up to determine an initial position for a working stroke at a predetermined forming energy and to set the initial position by controlling and/or regulating the second hydraulic valve during a return stroke, whereby the control unit is preferably set up to variably, in particular dynamically variably, set the initial position based on a free path length of the bear between the initial position and the forming position of a preceding working stroke.

In the proposed forming machine, proportional valves can be used particularly advantageously for the first and second hydraulic valves. The two valves can be of identical design, whereby one of them may be provided for impact triggering and the other as a lifting valve. The valves can be designed in the so-called cartridge design, whereby control and logic elements can be installed on the control cover in a vibration-resistant manner. An integrated safety stage can be used to ensure that the first hydraulic valve, in particular an impact valve, is ready to receive.

The proposed forming machine has the particular advantage that the hydraulic cylinder requires only two (in particular only exactly two) hydraulic connections, one for the working stroke and one for the return stroke. Compared to forming machines of the prior art with four functionally different hydraulic connections on the hydraulic cylinder, the design can therefore be simplified.

As mentioned, the hydraulic cylinder can have a lower connection (first hydraulic connection), which is provided for the return stroke. The lower connection permanently and always provides hydraulic fluid, for example hydraulic oil, or operating pressure (e. g. in the range between 197 bar to 203 bar, preferably at around 200 bar). Thus, in advantageous embodiments, it is provided that the lower or first hydraulic connection does not include direct control via a hydraulic valve. If the lower or first hydraulic connection is subjected to the system pressure (e. g. approximately 200 bar), the return stroke can be performed via the lifting valve (second hydraulic valve) on the second or upper hydraulic connection.

The first and second hydraulic valves (impact valve and rising valve) are connected to the upper hydraulic connection (second hydraulic connection) or second cylinder chamber, respectively. The hydraulic cylinder is controlled/regulated accordingly at the upper or second hydraulic connection.

It is advantageous to use proportional valves for impact and lifting for the hydraulic valves.

In embodiments, for example in large forming machines, several valves for each function (impact/lifting) can be connected in parallel as hydraulic valves or valve units.

The use of a proportional valve for the lifting or for the return stroke opens up the possibility of operating the forming machine with a variable starting position or stroke starting position instead of a fixed top dead center, as the braking process can essentially be started at any position, for example at any height, or the bear can be brought to a standstill at any height.

In particular, it is possible according to embodiments that the hydraulic valve is closed in a continuous manner during the return stroke according to a predetermined characteristic curve, for example in order to realize an initially gentle but precise stop towards the end of the return stroke. For the operation of the forming machine, it can be advantageously provided that the bear is only brought to a standstill when it has reached at least the starting height required to accelerate the bear for the next stroke.

In particular, the proposed control of the hydraulic valves can be used to ensure that the high volume flow generated by the rebound can be safely reduced during the subsequent braking phase or during the return stroke, especially in the event of bounces.

For operational safety, e. g. in the event of failure of the electronics of the lifting valve, a rod extension can be provided above the piston, which plunges into a bore and thus forms a hydraulic brake cushion, which is described in more detail below.

By using a proportional valve to accelerate the bear, several control variables, in particular, are available with which the acceleration phase may be controlled. These include, for example, adjustable characteristic curves for opening and closing the first hydraulic valve or impact valve, the actual opening and thus the controllable volume flow that can flow through it and the time for which the hydraulic valve remains open. Both the absolute accuracy and the repeatability of the machine can be improved as a result.

With the proposed forming machine and the associated operating method, it is possible in particular for the strokes or working strokes to always be executed from an individually suitable or necessary height when operating the forming machine with proportional valves. In particular, it is not necessary to move to the absolute upper end position of the hydraulic cylinder after each stroke or working stroke. In addition, the variability offered by a proportional valve as a stroke valve can improve the accuracy of the strokes.

In the practical operation of a forming machine, for example in an automatic forging line, it may be necessary to provide a certain amount of clearance between the upper and lower tool for die maintenance, handling tasks, etc. This can be provided by the use of proportional elements. This can be provided by the use of proportional elements, because the top dead center or reversal point of the bear is variable.

The following operating modes represent procedural embodiments of the invention or functional embodiments of the control unit or the hydraulic control unit.

In one embodiment, forming, in particular forging, can be provided with automatic energy adjustment. After inserting a blank or a workpiece into the lower die of the forming machine, a set-stroke can first be performed with low energy. A set-stroke is to be understood, for example, as a stroke in which the upper die or swage is lowered onto the workpiece, whereby the bear is moved onto the workpiece with a low energy, for example so that essentially no or only negligible deformations occur on the workpiece. The control unit determines the available stroke path. A subsequent stroke can then be carried out automatically with the maximum energy achievable for this determined stroke distance, whereby the stroke and the acceleration of the bear are automatically controlled or regulated by the control system on the basis of the determined stroke distance.

Due to the deformation of the workpiece or forged part, a longer stroke distance is now available for the subsequent working stroke or impact, which in turn can be automatically determined and converted into an increase in impact energy. The process can be identical for all subsequent strokes. According to embodiments, it is also possible that a limit value is set before the start of an impact sequence in such a way that, for example, when a predetermined nominal energy of the forming energy is reached, for example 80% of the nominal energy of the forming machine, and/or when a selectable or predeterminable lower reversal point is reached, which can correspond to the component end height, for example, no further automatic increase in the impact energy takes place. The limit value can be set by a user, for example. A corresponding operation with limitation of the, e. g. maximum, energy and/or the criterion of the lower reversal point, e. g. the component end height, is particularly useful for upsetting (heading) and stretching operations in which the component height changes significantly during forging.

According to embodiments, an operating mode can be provided in which forming or forging takes place from a preselected height with adjustable energy.

For this purpose, an essentially freely selectable impact starting position or starting position for executing a working stroke, as well as a die height and a blank or workpiece height can be specified automatically or by an operator. The control unit uses this to determine the maximum achievable energy. Individual strokes or individual working strokes or a sequence of working strokes or strokes with energies between 1% of the maximum impact energy of the forming machine and the previously determined achievable maximum energy can then be programmed or set.

In embodiments, the control system can be set up to constantly carry out plausibility checks between the entered or specified data and the working strokes or return strokes actually performed and to stop the operation of the forming machine if the automatically determined operating parameters exceed or fall below limit values. As an alternative to data input by a user, an initial set-stroke of low energy can be used in this operating mode to determine the initially available working stroke.

According to embodiments, an operating mode can be provided in which forging takes place with constant energy from an optimum height.

Here it is possible to fix or define a freely selectable energy level. In addition, the die and component height can be entered or determined, for example by means of a set-stroke and continuous determination of the position of the bear at the reversal point. The control system may use the corresponding data to determine an optimum height or an optimum starting point for a sequence of working strokes or an impact sequence and execute a corresponding sequence of working strokes, e. g. with the same energy in each case.

According to embodiments, it may be provided that during operation of the forming machine all blows, whether in continuous blow or single blow mode, are always executed from the uppermost end position with the energy specified, for example, by the operator. This corresponds in particular to the operation of a conventional forging hammer with four hydraulic connections, and shows that the proposed forming machine can be operated flexibly.

In addition to the advantages already mentioned, the use of proportional valves has a number of other positive aspects. Whereas with conventional drives, the braking distance as a proportion of the total stroke increases as the energy decreases, proportional valves can be used to stroke from a reduced height. On the one hand, this saves acceleration work and, on the other hand, the stroke frequency may be increased. A cartridge design of the proportional valves also makes them easier to install and maintain, as they may be mounted and connected in just a few simple steps. The design of the tried-and-tested block hydraulics is also simpler, as fewer oil-carrying channels need to be manufactured.

It should be particularly emphasized that the new hammer drive with proportional valve technology no longer requires a suction phase via a separate suction valve in the usual sense. The suction valve, suction tank and all the disadvantages associated with the suction phase can be dispensed with. Essentially, this means that no more unsettled oil, possibly containing air pockets, enters the piston chamber, thus eliminating the risk of cavitation.

In the proposed forming machine with proportional valves, it is particularly advantageous if the acceleration phase of the bear is completed before forming begins. This prevents the piston chamber from still being connected to the accumulator via the proportional valve for impact at the moment of impact and at the same time the bear generating an opposing volume flow due to the rebound, which could result in uncontrollably high pressure peaks in the hydraulic system that could damage the system. It should also be mentioned that by ending the acceleration phase before forming begins, which corresponds to “releasing” the bear—technically speaking, it is taken out of the control system—also shapes the character of the impact machine.

On the one hand, the flow of hydraulic fluid into the second cylinder chamber or piston chamber must not end until the bear reverses direction; on the other hand, the acceleration phase must be completed before forming begins. This can be achieved by clever control of the two proportional valves. An overlap phase provided according to embodiments, in which both valves are open to a certain degree, can ensure that oil may both inflow into the piston chamber and flow out after completion of the acceleration phase until the bear reverses direction.

Fluid engineering simulations and tests in practice have shown that the forming machine and hydraulic control system proposed herein, especially when using proportional valves, can be set up in such a way that no pressures below 3 bar occur in the hydraulic system, especially in the hydraulic cylinder. As air is only released from oil at pressures below 1 bar, no harmful cavitation can occur. To avoid excessively high pressures, the hydraulic system may be equipped with additional safety valves that function independently of the electronics. In embodiments, pressure sensors may be provided, on the basis of which the proper functioning and adjustment of the system may be checked.

One advantage of eliminating the inflow phase and the associated air exchange is that only small, low-maintenance tank ventilation filters and no large hood filters are required. The necessary piping is also no longer required. Filter and cooling units no longer need to be designed according to the amount of oil required in the suction tank, but can be designed according to the actual heat development in the system.

According to a further embodiment of the invention, which in particular can be claimed independently, a hydraulic forming machine, in particular a forging hammer, is provided for workpiece forming.

The hydraulic forming machine, hereinafter also referred to as forming machine for short, comprises a hydraulic circuit with a unit for generating a predetermined system pressure (for example in the range between 190 bar to 210 bar, in particular 197 bar to 203 bar, preferably at around 200 bar) for the hydraulic liquid (or: the hydraulic fluid), for example a pressure accumulator and/or a pump unit, and at least one, in particular unpressurized, reservoir, for example a return and/or suction tank, for hydraulic liquid. A pressure accumulator and/or the pump unit may be used to provide hydraulic fluid in accordance with a predetermined system pressure. The reservoir is preferably unpressurized, i. e. not subjected to system pressure. The return and suction tanks can be separate tanks. However, it is also possible for the return and suction tanks to be the same tank.

The forming machine further comprises a hydraulic cylinder comprising a cylinder tube having a piston movable therein between a first end and a second end. The piston is coupled to a piston rod extending towards the first end and coupled or couplable to a bear.

On the side facing away from the piston rod, the piston has a rod extension (or: piston extension), in particular a cylindrical extension, extending towards the second end. The rod extension can be designed as a separate component or can be formed by a terminal section of the piston rod, whereby in the latter case the piston rod can engage axially through the center of the piston, for example, so that the piston rod projects or protrudes beyond the piston on the side of the piston facing away from the piston and forms the rod extension. The rod extension has an outer diameter that is smaller than that of the piston.

At the second end or in the region of the second end, the hydraulic cylinder has a bore which is coaxial with the rod extension and open towards the piston, the inner diameter of which corresponds essentially to the outer diameter of the rod extension, or is slightly smaller. The diameters mentioned are selected so that the rod extension can plunge into the bore, in particular so that the hydraulic fluid in the bore acts as a brake cushion. Advantageously, the depth of the bore measured coaxially to the rod extension is greater than the length of the rod extension that can be plunged into the bore. In particular, the depth of the bore is preferably selected such that when the rod extension is plunged into the bore, it does not touch the bottom of the bore, i. e. is spaced from the bottom. With regard to the diameter of the bore, this may have a smooth dimension, for example 45 mm, and the rod extension may have a slightly smaller diameter, for example 44.6 mm. The diameter of the bore or the rod extension is preferably selected as a function of the size of the forming machine, e. g. as a function of the diameter of the piston of the hydraulic cylinder.

In embodiments, the outer diameter of the piston extension essentially corresponds to the outer diameter of the piston rod, or is the same as the outer diameter of the piston rod.

The hydraulic cylinder or the cylinder tube has a first hydraulic connection in the area of the first end and a second hydraulic connection in the area of the second end.

A hydraulic connection is to be understood as a connection of the hydraulic cylinder which is intended to supply hydraulic fluid to or from an assigned cylinder chamber of the hydraulic cylinder during hydraulic operation of the hydraulic cylinder.

In particular, there are no further hydraulic connections in the aforementioned sense and with the aforementioned function between the first and second hydraulic connections. This means that the hydraulic cylinder and correspondingly the forming machine can be constructed in a comparatively simple manner.

The second hydraulic connection is arranged and designed such that the piston closes the second hydraulic connection during a movement towards the second end when the rod extension reaches a side of the piston extension facing the second end of the bore, in particular when the rod extension reaches the opening of the bore. Preferably, the second hydraulic connection, the rod extension and the opening are arranged and formed in such a way that the second hydraulic connection is closed by the piston at approximately the same time as the opening is closed by the distal end of the rod extension. A volume of hydraulic fluid trapped in the bore and in the annular space around the rod extension can then act as a brake cushion.

The advantage of the combined effect of the rod extension and bore on the one hand and the closure of the second hydraulic connection on the other lies in the braking effect this achieves for the unit comprising the piston, the piston rod and the bear with tools attached to it. If the rod extension closes the opening of the bore, for example when the rod extension plunges into the bore, the hydraulic fluid in the bore develops a braking effect. Furthermore, the hydraulic fluid present in the annular space around the rod extension when the second hydraulic connection is closed also generates a braking effect. Consequently, the piston and associated components, such as the piston rod, bear, tools, etc., can be braked efficiently, especially if, for example, an electronic, hydraulic control or regulation system provided for controlling the hydraulic cylinder via the first and second hydraulic valves with associated hydraulic valves fails or is defective. The bore with rod extension therefore forms a brake that works independently of other hydraulic components, in particular control or regulation units. In this respect, the bore can be described as a type of brake bushing. Since the brake operates in particular independently of other hydraulic components, i. e. is defined solely by the structure of the bore, the rod extension and the position of the second hydraulic connection, these components, in particular the bore with rod extension, can also be used as an emergency or safety brake system. However, the components may be used not only for emergency braking in the event of a system failure, but also in regular operation to slow down the movement of the piston in the direction of the second end.

In embodiments, it may be provided that the volume of the bore formed by the rod extension when the opening is closed and the annular space of the second cylinder chamber formed around the rod extension are connected to each other with the interposition of a throttle, e. g. via a line. For example, a connecting line containing the throttle can run between the base of the bore and the annular base of the second cylinder chamber formed around the opening of the bore. When the rod extension closes the opening and the piston closes the second hydraulic connection, pressure equalization between the volume of the bore and the volume of the annular space can take place via the throttle. This allows, for example, comparatively gentle and efficient braking.

The rod extension is preferably arranged coaxially to the piston, which means that tilting moments can be essentially avoided during braking.

In embodiments, the radius of the rod extension can be between ⅓ and ⅔ of the radius of the piston, in particular, for example, ½ times the radius of the piston.

The axial length of the rod extension and/or the outer diameter of the rod extension may be adjusted depending on the size of the forming machine and/or depending on the diameter of the piston of the hydraulic cylinder.

In embodiments, the piston rod and the rod extension are manufactured in one piece. For example, the piston rod may extend through the piston and protrude beyond the piston in the direction of the second end, whereby the protrusion or the protruding part or a part protruding beyond the piston may form the rod extension. However, it is also possible that the piston rod and rod extension are two separate components which are attached or fixed to opposite ends of the piston. The piston rod, whether with or without rod extension, may be made as a whole from a forged blank, for example, whereby advantageous mechanical stability can be achieved.

According to embodiments, the respective annular area of the piston, i. e. the area formed by the end face of the piston minus the cross-sectional area of the piston rod or rod extension, is essentially or approximately the same size (e. g. within deviations of up to 5% or 10%) as the cross-sectional area of the piston rod or rod extension. If, for example, the diameter of the piston rod or rod extension is 45 mm, which corresponds to an area of approx. 15.9 cm², and the diameter of the piston is 63 mm, for example, which corresponds to an area of approx. 31.2 cm², the ring area is: 31.2 cm²-15.9 cm²=15.3 cm² with a piston rod area of 15.9 cm². In this example, the ring area essentially corresponds to the piston rod area or the rod extension area, in particular within a deviation of between 3.5% and 4%.

According to embodiments, the first hydraulic connection may be connected or connectable to the hydraulic circuit in such a way that a first cylinder chamber of the hydraulic cylinder connected to and downstream of the first hydraulic connection is pressurized or may be pressurized with a predetermined system pressure, in particular with the pressure generated by the unit for generating the system pressure, for example a pressure accumulator and/or a pump unit. During operation of the hydraulic cylinder, the first cylinder chamber is preferably always pressurized with system pressure. Consequently, the system pressure is present in the first cylinder chamber, which is formed as an annular space due to the piston rod running through the first cylinder chamber. Apart from the annular volume formed around the rod extension, the second cylinder chamber facing away from the piston rod is hollow cylindrical, i. e. not entirely an annular chamber. If the system pressure is also present in the second cylinder chamber during an operating phase, this results in a force with which the piston is accelerated in the direction of the first end.

A movement or acceleration of the piston towards the first end is preferably used for a working stroke, during which the bear coupled to the piston is accelerated to a target speed intended for forming or for an impact. Preferably, the movement during the working stroke is from top to bottom. During a working stroke, the second cylinder chamber is filled with hydraulic fluid, preferably at least temporarily by applying system pressure. Consequently, the second cylinder chamber may also be referred to as a stroke chamber. Correspondingly, a movement of the piston towards the second end can be used for a return stroke, preferably a movement from bottom to top, during which the piston or bear is moved into an initial position intended for executing a subsequent working stroke or impact. Consequently, the first cylinder chamber, which is designed in particular as an annular chamber, may be described as a return stroke chamber of the hydraulic cylinder.

Preferably, the hydraulic cylinder in the ready-to-use forming machine is arranged substantially vertically, i. e. the piston moves along a vertical axis with the first end at the bottom and the second end at the top. A forming cycle can be executed by applying system pressure to the return stroke chamber and the stroke chamber when the working stroke is triggered, resulting in a force acting downwards towards the first end which, together with the weight of the piston, piston rod and bear and possibly other components such as tools on the bear, causes the bear to accelerate downwards. After performing a forming operation or an impact, the stroke chamber can, for example, be connected to a reservoir, such as a return tank, without pressure, so that the system pressure acting in the return stroke chamber causes an upward return stroke. By suitably controlling or regulating the hydraulic flows in and out of the cylinder chambers, the bear can be accelerated to a target speed during the working stroke and positioned at a desired starting position or starting position for a subsequent forming operation during the return stroke. Suitable hydraulic controls and the associated system configurations are described in more detail below. What all embodiments have in common, however, is that the rod extension and the bore act as a brake at the second end to slow down the return stroke movement if required.

According to an advantageous embodiment, the hydraulic circuit comprises a valve unit connected or connectable to the second hydraulic connection. The hydraulic circuit and the valve unit are preferably set up such that a second cylinder chamber of the hydraulic cylinder connected to the second hydraulic connection may optionally be pressurized at least temporarily with hydraulic pressure, in particular at least temporarily with the system pressure, for example by connection to the pressure accumulator, or may be connected at least temporarily without pressure to the reservoir, e. g. a return tank, via the valve unit when performing a working stroke. For example, in an acceleration phase after triggering a working stroke to accelerate the bear to the target speed, the valve unit can be controlled or regulated in such a way that the second cylinder chamber is pressurized with system pressure, for example by being connected to the pressure accumulator. After reaching the target speed and/or during the return stroke, the valve unit may be controlled or regulated so that the second cylinder chamber is connected to the return tank without pressure, for example.

After reaching the target speed, the second cylinder chamber may be connected to a suction tank during the working stroke, for example, so that hydraulic fluid can be sucked into the second cylinder chamber essentially without pressure in accordance with the increase in volume of the second cylinder chamber due to the movement of the piston towards the first end. The suction after reaching the target speed or a corresponding suction volume flow is preferably regulated or controlled by the valve unit in such a way that the target speed is essentially maintained and/or that a predetermined forming speed is reached. For example, the suction volume flow can be regulated or controlled so that there is a balance of forces between weight forces and pressure forces in the second cylinder chamber on the one hand and pressure forces in the first cylinder chamber on the other. If a balance of forces cannot be achieved, the suction volume flow is preferably regulated and/or controlled in such a way that the bear reaches a predetermined forming speed. Advantageously, the acceleration phase and/or the suction phase is regulated or controlled in such a way that the hydraulic pressure in the parts of the hydraulic circuit affected by the suction is above the cavitation pressure of the hydraulic fluid.

After forming, the second cylinder chamber may be connected via the valve unit to an unpressurized reservoir, e. g. a return tank, so that the system pressure prevailing in the first cylinder chamber causes the return stroke movement. During the return stroke, a return stroke volume flow resulting from the second cylinder chamber into the reservoir or the return tank may be controlled or regulated, for example, by controlling or regulating the valve unit so that the return stroke movement ends at a predetermined starting or starting position for a subsequent working stroke. This makes it possible, for example, to select the starting or starting position of the piston in the cylinder tube essentially at will, which means that by suitable control or regulation of the return stroke by the valve unit, the starting position is not necessarily located at the second end, or is not exclusively determined by the brake defined by the rod extension and bore. Further details on this are described in more detail below.

According to a preferred embodiment, the valve unit comprises a controllable or adjustable first hydraulic valve connected or connectable to the second hydraulic connection, for example an impact valve for triggering a forming stroke or a working stroke, and a controllable or adjustable second hydraulic valve connected or connectable to the second hydraulic connection, for example a lifting valve for executing a return stroke.

In one switch position or control or regulating position, the first hydraulic valve is set up to pressurize the second cylinder chamber at least temporarily with hydraulic pressure, in particular system pressure, for example by connecting it to the pressure accumulator, via the second hydraulic connection when performing the working stroke. In one switch position or control or regulating position, the second hydraulic valve is set up to connect the second cylinder chamber via the second hydraulic connection to the reservoir, in particular a suction tank, at least temporarily without pressure when performing the working stroke. Consequently, a control or regulation of the working stroke may be provided or set up by which the first hydraulic valve is controlled, e. g. opened, in such a way that system pressure is applied to the second cylinder chamber to trigger a working stroke and accelerate the bear to the target speed. The opening or opening width of the first hydraulic valve may, for example, be controlled or regulated in such a way that the pressure forces on the piston resulting from the second cylinder chamber are greater than the pressure forces resulting from the first cylinder chamber, for example from the system pressure. In particular, it is possible to regulate or control the acceleration or the acceleration process, for example according to a predetermined target curve for the movement or acceleration and/or as a function of the desired target speed or forming speed.

Once the target speed has been reached, the control or regulation may provide for the first hydraulic valve to be closed, for example, and the second hydraulic valve to be opened, so that hydraulic fluid is sucked into the second chamber, for example, from the reservoir, e. g. the suction tank, without pressure. Preferably, the opening or opening width of the second hydraulic valve and thus the suction volume flow is controlled or regulated in such a way that the piston continues to move essentially at the target speed, or that the forming speed is reached and/or the pressure is above the cavitation pressure, i. e. that the pressure is not so low that the air dissolved in the oil is released (cavitation).

The described operation of the forming machine with only two hydraulic connections and the proposed brake unit consisting of the cylinder extension and bore enable, in particular, precise adjustability of the target speed or forming speed of the bear while at the same time ensuring safe operation, for example in the event of a failure of the control or regulation of the hydraulic valves.

According to embodiments, the valves or hydraulic valves may have an integrated safety stage. Specifically, an integrated safety stage may be implemented in such a way that a safety valve assigned to the hydraulic valve or a safety valve integrated into it must be pressurized before the actual hydraulic valve, e. g. a piston of a cartridge valve, may be controlled or regulated, or released for control or regulation by the safety stage.

According to embodiments, a corresponding safety level may be assigned to the impact valve, for example. Such a safety level can be used, for example, to realize the readiness for acceptance of the forming machine or the hammer. If, for example, the safety stage is pressurized, this corresponds to an operating state in which the execution of an impact is enabled.

Advantageously, the hydraulic valves are electrically controlled and closed when de-energized. As a result, uncontrollable movements of the bear or hydraulic cylinder may be avoided, e. g. in the event of a power failure, as pressure or the system pressure is present in the hydraulic system, e. g. in the accumulator, even when the valves are de-energized.

According to one embodiment, the first hydraulic valve is set up or controlled in such a way that it assumes a closed position at least temporarily during the working stroke, for example during the acceleration phase of the bear, and/or at least temporarily during a return stroke, preferably essentially during the entire return stroke. The first hydraulic valve is preferably regulated or controlled into the closed position during a working stroke when the target speed is reached and the second cylinder chamber is connected to the reservoir or suction tank via the second hydraulic valve. In particular, the second hydraulic valve can be set up or controlled in such a way that the second cylinder chamber is connected to the reservoir or suction tank without pressure when the first hydraulic valve is in the closed position, for example after the target speed has been reached. For this purpose, the second hydraulic valve may be controlled or regulated to the or an open position.

According to one embodiment, the forming machine further comprises a hydraulic control unit, in particular control unit or control unit, for controlling and/or regulating the hydraulic circuit, in particular the hydraulic valves, wherein the hydraulic control unit is set up, in particular programmed, for operating, in particular for controlling or regulating, a hydraulic forming machine according to one of the embodiments according to the invention described herein.

The hydraulic control unit comprises a processor and/or control electronics or regulating electronics, which is or are set up to control or regulate the opening width of the first hydraulic valve when performing a working stroke intended for forming a workpiece in such a way that
in a first phase, the first hydraulic valve is opened and the bear is accelerated to a target speed in the first phase,
in a second phase following the first phase, in particular after reaching the target speed, the opening width is decreased or is reduced to a predetermined inflow opening width, and
the first hydraulic valve is or becomes closed in the area of the forming position of the bear and during a return stroke that runs in the opposite direction to the working stroke.

With regard to further embodiments of the hydraulic control unit and with regard to advantages and advantageous effects of the hydraulic control unit, reference is made to the explanations relating to the hydraulic forming machine, which are applicable accordingly to the hydraulic control unit.

All operating modes of the hydraulic forming machine and the control unit or the hydraulic control unit can also be claimed as operating methods within the scope of the invention, whereby corresponding functional features are to be understood as method steps. A corresponding method can provide the following method steps for the aforementioned hydraulic control unit or for a corresponding forming machine:
in the first phase of the working stroke, opening the first hydraulic valve and accelerating the bear to a target speed,
in a second phase following the first phase, in particular after reaching the target speed, reducing the opening width to a predetermined inflow opening width, and
closing of the first hydraulic valve in the area of the forming position of the bear and during a return stroke that runs in the opposite direction to the working stroke.

According to embodiments of the hydraulic control unit, it may be provided that
the hydraulic circuit further comprises a second hydraulic valve which is connected to the hydraulic connection, and wherein the hydraulic control unit is arranged to control an opening width of the second hydraulic valve, which is preferably designed as a proportional valve, in such a way that an initial position of the bear for a subsequent working stroke is variably adjustable in the case of a return stroke which is effected in the opposite direction to the working stroke, and/or
the forming machine further comprises a measuring unit for determining the position of the bear, wherein the hydraulic control unit is set up to determine one or more operating parameters, such as an initial position and/or a target speed and/or an impact energy of the bear, for a subsequent working stroke on the basis of a forming position determined by the measuring unit for a preceding working stroke, wherein, preferably, an initial working stroke is set up as a set-stroke carried out at minimum impact energy, and/or
the hydraulic control unit is set up to control the opening width of the first hydraulic valve on the basis of a variably predeterminable and/or determinable starting position and a variable forming position (reversal position/rest position), in particular a variably predeterminable and/or determinable forming position, in particular such that the working stroke, in particular a forming stroke, can be executed with a respectively suitable, preferably predetermined, in particular a respectively maximum achievable impact energy and/or.
the hydraulic control unit is set up to variably adjust an initial position for executing a working stroke, in particular as a function of at least one operating parameter of the hydraulic cylinder with respect to one or more preceding working strokes, the operating parameter preferably being an operating parameter detected by one or more sensor units, and/or
the hydraulic control unit is set up to determine an initial position for a working stroke at a predetermined forming energy and to adjust it by controlling and/or regulating the second hydraulic valve during a return stroke, the hydraulic control unit preferably being set up to variably adjust the initial position on the basis of a free path length of the bear between the initial position and the forming position of a preceding working stroke.

According to a, particularly independently claimable, embodiment, the forming machine further comprises a control unit or control unit (or: hydraulic control unit) for controlling and/or regulating the hydraulic circuit, in particular the hydraulic valves, wherein the control unit is set up, in particular programmed, for this purpose:
to apply hydraulic pressure, for example system pressure, to the second cylinder chamber during a working stroke and to accelerate the bear to a target speed,
during the working stroke and after reaching the target speed, the second cylinder chamber is essentially depressurized or pressurized with hydraulic pressure which is reduced compared to the system pressure, e. g. in such a way that a balance of forces prevails at the piston and/or the target speed is essentially maintained; and
the second cylinder chamber is depressurized on a return stroke; whereby
the first cylinder chamber is pressurized with system pressure during the working stroke and return stroke.

According to an advantageous embodiment, the control unit is set up, in particular programmed:
during the working stroke, to control or regulate the first hydraulic valve into an open position, in which the second cylinder chamber is or becomes pressurized with hydraulic pressure via the first hydraulic valve, for example at least temporarily with the (full) system pressure, until a predetermined target speed of the bear is reached, and at the same time to control or regulate the second hydraulic valve into a closed position,
b) during the working stroke and after or when the target speed is reached
b1) to control or regulate the first hydraulic valve into a closed position and, by controlling or regulating the second hydraulic valve into an open position, to connect the second cylinder chamber to the reservoir, in particular a suction tank, via the second hydraulic valve and/or via a suction valve and to generate a suction volume flow in the second cylinder chamber with which the target speed is essentially maintained and/or with which a predetermined forming speed is achieved at the forming time; or
b2) by controlling or regulating the open position of the first hydraulic valve via the first hydraulic valve and/or via a suction valve, to generate an inflow volume flow into the second cylinder chamber, with which the target speed is essentially maintained and/or with which a predetermined forming speed is achieved at the forming time, the second hydraulic valve preferably being controlled or regulated into the closed position;
to control or regulate the second hydraulic valve connected to the second hydraulic connection to the open position and the first hydraulic valve connected to the second hydraulic connection to the closed position during a return stroke following the working stroke.

In brief, the control unit according to a) effects an operation in which the bear is accelerated by controlled or regulated application of hydraulic pressure to the second cylinder chamber, for example to a target speed which, for example, essentially corresponds to a predetermined forming speed or with which the forming speed is reached at the time of forming.

The target speed for the impact forming machine is reached before the tool hits the workpiece or forged part. This means that the acceleration process is completed before the tool hits the workpiece or forged part. In the process sequence, the first hydraulic valve or impact valve is actually closed at the latest when the forming process begins or the bear changes direction, i. e. moves in the return stroke direction. As the hydraulic system has a certain reaction time, the first hydraulic valve or impact valve may be controlled accordingly so that it is safely closed when forming begins or the bear changes direction. Otherwise, there would still be system pressure in the piston chamber and the reversing bear would also push hydraulic fluid upwards, which would result in uncontrollably high pressure peaks and damage to the hydraulic system and/or hydraulic cylinder.

According to embodiments, the acceleration phase a) and in particular the phases b1) and b2) are set up in such a way that no cavitation occurs in the hydraulic fluid. In particular, the acceleration phase and the subsequent phase can be coordinated with the downstream flow rate so that the pressure in the hydraulic fluid is above the cavitation pressure.

In the process sequence of the impact forming machine, it is intended that the second hydraulic valve or lifting valve is safely opened or switched to the reservoir before the bear changes direction, i. e. moves in the return stroke direction. In order to take account of the reaction times of the system, the second hydraulic valve or lifting valve may be controlled so that it is safely open when the bear changes direction. For example, the lifting valve or second hydraulic valve may be opened as soon as the acceleration phase is or will be completed. If the lifting valve were not open, there would be no way for the hydraulic fluid to move when the bear changes direction, which would lead to damage as a result of high pressures.

Consequently, at the end of the acceleration phase, there may be an overlap of “impact end” and “lifting start”, for example if the first hydraulic valve or impact valve and the second hydraulic valve or lifting valve are open simultaneously in an overlap phase. In this state or the overlapping phase, the bear is essentially removed from the control (the bear is “released”) and can then impact-form the workpiece. In particular, it can therefore be provided that the bear is removed from the control system at least during forming, advantageously—taking into account the reaction times of the hydraulic system—even before forming.

According to steps b1) and b2, the suction volume flow may be generated at least partially via a suction valve, whereby in this mode of operation the suction volume flow may be generated either completely via the suction valve or via the suction valve and the first/second hydraulic valve. As steps b1) and b2) show, it is possible in particular for the suction volume flow to be generated via the first/second hydraulic valve, so that a suction valve is not absolutely necessary.

For example, there are the following two alternatives for the further working stroke after reaching the target speed.

In one mode of operation according to b1), the first hydraulic valve may be closed and the second hydraulic valve may be opened. This results in an unpressurized suction volume flow into the second cylinder chamber on the system side, which compensates or balances out the increase in volume of the second cylinder chamber due to the hydraulic fluid being sucked in. The open position of the second hydraulic valve may be regulated or controlled in such a way that the target speed is maintained and/or the forming speed is achieved, should this be necessary. The suction volume flow can alternatively or at least partially take place via a separate suction valve.

In the alternative mode of operation according to b2), it may be provided that the first hydraulic valve is not completely closed, with the second hydraulic valve preferably remaining closed. For example, the first hydraulic valve may be regulated or controlled only partially into the closed position, so that a pressure-based inflow volume flow is established, which generates a reduced pressure in the second cylinder chamber compared to the system pressure. The inflow volume flow can be regulated or controlled in such a way that the bear is not accelerated further and the target speed is essentially maintained. The valves may be controlled and/or regulated, for example, on the basis of predetermined control and/or regulation curves, which may be determined, for example, from a test operation of the forming machine and/or by simulation. A suction volume flow via a suction valve is also possible in this mode of operation, which may take place via the suction valve and/or the first hydraulic valve.

If the first hydraulic valve or the impact valve is closed at the end of the acceleration phase, either completely, which would be accompanied by suction, or only partially, which would be accompanied by inflow, a braking effect on the bear occurs as a result of the system pressure applied to the ring side of the hydraulic cylinder. In this respect, the wording “the target speed is essentially maintained” or “a predetermined forming speed is reached at the time of forming” should be understood to mean that the acceleration phase is set up in such a way that the speed of the bear intended for forming is present despite any braking forces that may occur after the time at which the acceleration phase is ended by at least partially closing the first hydraulic valve. If, for example, a stroke is to be executed at 5 m/s, which may correspond to 100% energy preselection on the forming machine, and the acceleration phase extends over a stroke of 450 mm, with a maximum available stroke of 500 mm until the tool hits the workpiece or forged part, there is a remaining distance of 50 mm. If braking forces act on this path, i. e. forces directed against the stroke movement, i. e. there is no balance of forces, the speed of the bear is slightly higher (e. g. 0.2 m/s) at the 450 mm stroke than at 500 mm. Corresponding braking forces or braking effects may be taken into account when controlling the first hydraulic valve or impact valve, or when controlling or regulating the acceleration phase, if relevant for the forming and the target speed.

In the suction phase or inflow phase, a certain force counteracting the movement of the bear, e. g. a force acting vertically upwards when the bear moves downwards during the stroke, may be desired. Such a force may at least increase the initial acceleration for the return stroke caused by the rebound. This can achieve that the tool, in particular the upper tool, separates from the workpiece, in particular the lower tool, again in a shorter or shortest time (e. g. a few milliseconds). Short pressure contact times are advantageous for long tool life.

A rebound always occurs when the bear brings more kinetic energy with it than can be converted into forming work during a forming or impact.

A particular advantage of the proposed forming machine and the forming process is that the braking phase following the acceleration phase (open impact valve) can be optimized so that optimum forming impacts can be set up or achieved.

As mentioned, the forming machine can be set up so that the bear moves downwards during acceleration and upwards during the return stroke. The bear moves vertically with a moving upper tool.

In the mode of operation according to c), which corresponds to the return stroke, the first hydraulic valve is closed and the second hydraulic valve is regulated or controlled to an open position, whereby the second cylinder chamber is connected to the reservoir or return stroke tank without pressure. The system pressure in the first cylinder chamber causes the return stroke movement. By controlling or regulating the open position of the second hydraulic valve during the return stroke, the effective return stroke force may be specifically controlled or regulated, in particular in such a way that the piston comes to a stop at a desired starting position for the next working stroke. The starting position may essentially be regulated or controlled at any point between the first and second hydraulic connections or between the two reversal points at the first and second ends. This results in particular in optimized motion control, whereby the piston does not have to be moved to the reversal point or dead centre at the second end with each return stroke, for example. For example, wear may be reduced and precisely reproducible working strokes and target speeds may be set or achieved.

Another advantage of the proposed forming machine or method is that the second hydraulic valve or lifting valve may be opened and closed in a targeted or controlled/regulated manner, for example by means of a suitable function or ramp. A corresponding control/regulation may provide that the second hydraulic valve or lifting valve is initially wide open (a lot of hydraulic fluid can flow out) to compensate for the rebound, then the second hydraulic valve or lifting valve may be closed continuously, for example, to generate an initially gentle braking during the return stroke, followed by a more rapid closing to finally obtain a targeted stop, e. g. at a predetermined position with little overflow (via the desired start position for a subsequent stroke) and high repeat accuracy.

According to embodiments, at least at the beginning or in the initial phase and/or acceleration phase of a further working stroke following the return stroke, the first and second hydraulic valves may be reversed or controlled in such a way that the first hydraulic valve is in the open position and the second hydraulic valve is in the closed position.

Preferably, the system pressure is applied to the first cylinder chamber via the first hydraulic connection, preferably from the pressure accumulator, during the working stroke and the return stroke.

According to one embodiment, a hydraulic forming machine according to one of the embodiments described herein is provided, which further comprises a displacement measuring system or a displacement measuring unit for detecting the position and/or speed of the piston, the piston rod and/or the bear. Position and/or speed data from the displacement measuring unit may be or are preferably used to control or regulate the hydraulic valves during the working stroke, for example as part of the acceleration to the target speed, and/or during the return stroke, for example as part of the positioning of the piston or bear in the starting position or starting position for a subsequent working stroke. As part of a control system, the target speed may, for example, be used as the reference variable and the position or speed determined in each case as the actual value for controlling the hydraulic valves.

According to one embodiment, the hydraulic circuit may further comprise at least one, preferably two, pressure transducers. For example, a first pressure transducer can be set up to detect the hydraulic pressure in the first cylinder chamber and a second pressure transducer can be set up to detect the hydraulic pressure in the second cylinder chamber. Preferably, the pressure transducer(s) are connected in a hydraulic line adjoining the first or second hydraulic connection. Pressure values of the pressure transducer(s) may, for example, be used to control or regulate the hydraulic circuit, in particular the valve unit or the hydraulic valves, in such a way that the hydraulic pressure in the hydraulic system, in particular in the cylinder chambers, is always or essentially always above the cavitation pressure of the hydraulic fluid. The pressure values may also or alternatively be used to control and/or regulate the hydraulic valves to achieve the target speed and forming speed. For this purpose, predetermined pressure curves may be provided to the control and/or regulation system, for example, and the control unit may be set up or programmed in such a way that the recorded hydraulic pressures follow the pressure curve.

In particular, it is possible that the control unit is set up or programmed in such a way that the determined position, speed and/or pressure values are used to control or regulate the hydraulic circuit according to predetermined position, speed and/or pressure curves. For example, it is possible to control or regulate the working stroke and/or return stroke on the basis of a predetermined position, speed and/or pressure curve in such a way that the actual values determined in each case follow the position, speed and/or pressure curve. Position, speed and/or pressure curves may, for example, be given in the form of value tables or other default data. In particular, position, speed and/or pressure may be given as set or target values as a function of time. It is also possible, for example, to use a position-velocity profile and/or a position-pressure profile and/or a pressure-velocity profile as a target- or set-point profile for controlling or regulating the working stroke and/or return stroke.

According to one embodiment, as already indicated above, the volume of the bore can be connected to the volume of the second cylinder chamber via a throttle, so that the bore is connected to the second cylinder chamber via the throttle in particular when the second hydraulic connection is closed by the piston and the opening is closed by the rod extension. Pressure equalization between the volume of the bore and the annular volume around the rod extension can be achieved by the throttle, in particular when the rod extension closes the opening of the bore at the second end.

According to one embodiment, a hydraulic control unit is provided for operating, in particular for controlling or regulating, a hydraulic forming machine according to one of the embodiments described herein. The hydraulic control unit comprises a processor and/or control electronics or control electronics, which is/are set up, in particular programmed, to control or regulate the hydraulic circuit in such a way that they carry out the steps explained below during operation. In particular, the processor, the control electronics and/or the control electronics may have programming and/or computer-readable or electronically readable instructions may be stored on an associated electronic memory unit, which, when executed by the processor, the control electronics and/or the control electronics, cause the steps described below. The hydraulic control unit is connected in terms of control technology and/or regulation technology at least to the hydraulic valves for their control/regulation, preferably also to the displacement measuring unit and/or the pressure transducers.

The aforementioned control and/or regulation steps may be set up in such a way that:
a) to accelerate the bear to a target speed, the second cylinder chamber is pressurized with hydraulic pressure, in particular with system pressure, in a controlled or regulated manner via a first hydraulic valve connected to it;
b) after or when the target speed is reached

b1) an inflow volume flow into the second cylinder chamber (45) is generated via the second hydraulic connection (38) via a suction valve and/or an, in particular pressure-based, inflow volume flow into the second cylinder chamber is controlled or regulated via the second hydraulic connection via the first hydraulic valve in such a way that the target speed is essentially maintained and/or a predetermined forming speed is reached at the forming time, or

b2) the first hydraulic valve is closed, and a suction volume flow is controlled or regulated via a suction valve and/or a suction volume flow, in particular an unpressurized suction volume flow, is controlled or regulated via the second hydraulic connection via a second hydraulic valve connected to the second cylinder chamber on the one hand and to the reservoir, in particular the suction tank, on the other hand in such a way that the target speed is essentially maintained and/or a predetermined forming speed is reached at the forming time.

For steps a), b) and b1) or b2), reference is made to the corresponding explanations above, which apply here accordingly.

In particular, a inflow volume flow or inflow is understood to be a pressure-based supply of hydraulic fluid, and a suction volume flow or suction is understood to be a pressureless suction of hydraulic fluid. With inflow, the hydraulic fluid is therefore supplied under pressure, which can be less than or equal to the system pressure, and with suction, the hydraulic fluid is supplied, i. e. sucked, through the system without active pressurization.

According to embodiments, the hydraulic control unit is furthermore set up to determine a position and/or speed of the piston, the piston rod and/or the bear via a displacement measuring unit of the forming machine, and to control or regulate the first and/or second hydraulic valve as a function of the determined position and/or speed, preferably according to a predetermined or predeterminable position or speed curve or profile. For example, based on the determined position and/or speed, the suction volume flow and/or the inflow volume flow during a working stroke and/or the volume flow from the second cylinder chamber during a return stroke can be regulated or controlled based on position and/or speed data, in particular in such a way that the target speed and/or the forming speed is reached and/or that a predetermined starting or starting position for a subsequent working stroke is reached.

According to embodiments, the hydraulic control unit is furthermore set up to determine the hydraulic pressure prevailing in the first and/or second cylinder chamber by means of a first and/or second pressure transducer of the forming machine, and to control and/or regulate the first and/or second hydraulic valve as a function of the determined hydraulic pressure, in particular according to a predetermined pressure curve and/or in such a way that the hydraulic pressure in the hydraulic circuit, in particular in the cylinder chambers, preferably in the second cylinder chamber, is essentially above the cavitation pressure of the hydraulic fluid.

According to embodiments, there is provided a hydraulic forming machine according to one of the embodiments described herein, comprising a hydraulic control unit according to one of the embodiments described herein.

According to embodiments, there is further provided a method, which can be claimed in particular independently, for operating, in particular for controlling or regulating a working stroke and return stroke, of a hydraulic cylinder of a hydraulic forming machine, in particular according to an embodiment described herein, or a method for operating a hydraulic forming machine, in particular according to an embodiment described herein.

The hydraulic cylinder comprises a cylinder tube with a stroke chamber, i. e. a cylinder chamber or cylinder chamber to which hydraulic fluid is supplied during a working stroke, and a return stroke chamber, i. e. a cylinder chamber or cylinder chamber to which hydraulic fluid is supplied during a return stroke.

The stroke chamber and return stroke chamber are separated from each other by a piston that can be moved in a cylinder tube of the hydraulic piston. The hydraulic cylinder further comprises a piston rod which extends on the return stroke chamber side and is connected or coupled to the piston on the one hand and a bear on the other hand, a rod extension formed on the piston on the stroke chamber side and a bore formed on the end of the cylinder tube on the stroke chamber side. The inner diameter of the bore essentially corresponds to the outer diameter of the rod extension, in particular in such a way that the rod extension can plunge into the bore. The bore is preferably in the form of a blind hole and has an opening oriented towards the rod extension. The bore and the rod extension are arranged and formed coaxially to one another, with the rod extension preferably also being formed coaxially to the piston and the piston rod.

The return stroke chamber has a first hydraulic connection and the lifting chamber has a second hydraulic connection. Apart from the two hydraulic connections, there are preferably no other hydraulic connections in the axial direction between the two hydraulic connections. Here, a hydraulic connection is understood to be a connection via which hydraulic fluid is supplied to or discharged from the respectively assigned chamber or the respectively assigned cylinder chamber, i. e. lifting chamber or return stroke chamber, for the purpose of active operation of the hydraulic cylinder, for executing the working stroke or return stroke.

In one embodiment of the method, the second hydraulic connection is closed by the piston during a return stroke when the rod extension reaches an opening of the bore facing the rod extension. This allows the piston to be braked at the second end of the cylinder tube during the return stroke.

In embodiments, the method comprises the following steps, in which:
the stroke chamber is pressurized with hydraulic fluid via the second hydraulic connection when a working stroke is triggered, in particular an impact, and at least temporarily during the working stroke for accelerating the bear from an initial position to a target speed, wherein the pressurization is controlled or regulated by a first hydraulic valve connected to the second hydraulic connection, and wherein a second hydraulic valve connected to the second hydraulic connection is controlled, i. e. closed, in the closed position,
when the target speed is reached during the working stroke
b1) a suction valve is used to generate a inflow volume flow and/or the pressurization and a inflow volume flow of hydraulic fluid generated thereby are controlled or regulated via the first hydraulic valve in such a way that the target speed is essentially maintained and/or a predetermined forming speed is reached at the forming time; or
b2) the first hydraulic valve is controlled or closed to the closed position, and the stroke chamber or the second hydraulic connection is connected, in particular without pressure, to a reservoir, e. g. a suction tank, via a suction valve and/or via a second hydraulic valve, wherein a suction volume flow resulting from the reservoir via the second hydraulic valve and the second hydraulic connection into the stroke chamber is regulated or controlled by actuating or controlling the second hydraulic valve, in particular the opening state of the second hydraulic valve, such that the target speed is essentially maintained and/or a predetermined forming speed is achieved at the forming time.
c) during a return stroke, the first hydraulic valve is or remains closed, the second hydraulic valve is opened and the second hydraulic connection is connected to the (unpressurized) reservoir, e. g. a return tank, whereby the piston subjected to system pressure via the return stroke chamber displaces hydraulic fluid from the stroke chamber into the reservoir via the second hydraulic connection and the second hydraulic valve.

With regard to advantages and embodiments of the method, reference is made to the corresponding explanations on the control or regulation of the stroke or return stroke in the forming machine.

With regard to the formulations “that the target speed (v(target)) is essentially maintained” and “a predetermined forming speed is reached at the forming time”, reference is made to the above explanations, which are applicable to all embodiments proposed herein. In particular, it is possible, for example, that the speed reached at the end of the acceleration phase is greater than the speed during forming, for example if the bear is braked after the end of the acceleration phase with the first hydraulic valve open, e. g. due to applied system pressure. Braking can take place, for example, on the last 5% to 15%, in particular 10%, of the working stroke or the stroke of the hydraulic cylinder, immediately before forming, and can be, for example, in the range of 0.1 m/s to 0.5 m/s, in particular at around 0.2 m/s.

According to embodiments according to the method, the method further comprises one or more of the following steps or features:

Determining the position and/or speed of the bear by means of a displacement measuring unit of the forming machine, and controlling or regulating the pressurization in step a) on the basis of the position and/or speed and the target speed or forming speed and/or controlling or regulating the pressurization in step a) on the basis of the determined position and/or speed and a predetermined position and/or speed profile.

Determining the position of the bear by means of a displacement measuring device and controlling or regulating the second hydraulic valve, in particular the opening state of the second hydraulic valve, during the return stroke in such a way that the bear or piston is positioned at the end of the return stroke in a predetermined or predeterminable, preferably variably predeterminable or variably selectable, starting position for executing a subsequent working stroke.

Sensing the hydraulic pressure in the stroke chamber by means of a pressure transducer of the forming machine and controlling or regulating the first and/or second hydraulic valve during a working stroke, in particular after reaching the target speed, on the basis of the hydraulic pressure sensed, in particular in such a way that the hydraulic pressure in the hydraulic fluid is essentially always above the cavitation pressure of the hydraulic fluid.
During the return stroke, the piston closes the second hydraulic connection when or as soon as the free or distal end of the rod extension reaches the opening of the bore facing the rod extension, so that the piston with piston rod and components moving with it are braked by the hydraulic fluid remaining between the piston and the bottom of the bore.

Setting, in particular regulating or controlling, the return stroke movement of the piston to the starting position as the starting point for a further or subsequent working stroke in such a way that the distance travelled by the piston from the starting position to reach the target speed is optimized, in particular maximized or minimized, and/or that a subsequent inflow phase according to b1) or suction phase according to b2) after reaching the target speed is optimized, in particular minimized.
To execute a return stroke, the first hydraulic valve is closed or remains closed, and the stroke chamber is connected to a reservoir, in particular a return tank, via the second hydraulic connection and the second hydraulic valve, wherein a return volume flow resulting from the stroke chamber into the reservoir is preferably regulated or controlled by actuating or controlling the intermediate second hydraulic valve in such a way that the bear or the piston is positioned at a predetermined position, in particular a suitable or desired, in particular predetermined, starting position for executing a subsequent working stroke, during the return stroke movement.
During the return stroke, the piston is controlled or braked in a controlled manner by controlling or regulating the opening state of the second hydraulic valve.

Controlling or regulating the opening state of the second hydraulic valve when the first hydraulic valve is closed during a return stroke in such a way that the piston is positioned in a controlled or regulated manner at a predetermined or predeterminable position, in particular the starting position for triggering a subsequent working stroke, based on a detected position of the piston, the piston rod or the bear during the return stroke, wherein the starting position is or is preferably selected as a function of the target speed to be achieved, and, further preferably, the starting position corresponds to a position of the piston which can be selected or predetermined, in particular essentially variably selectable or predeterminable, between the first hydraulic connection and the second hydraulic connection.
The rod extension and the bore act as a kind of emergency brake, especially if the hydraulic control, for example the second hydraulic valve, fails during a return stroke. The braking effect of the rod extension and the bore can of course also be used during regular operation, for example if the starting point for a working stroke corresponds to a position of the piston in the area of the second end.
The first hydraulic valve and the second hydraulic valve are controlled or regulated in process step b2) in such a way that both hydraulic valves are at least partially opened at times simultaneously in the area of the time at which the target speed is reached in an overlap phase, so that an essentially uninterrupted hydraulic fluid flow to the stroke chamber is achieved.
An inflow in step b1) comprises a supply of hydraulic fluid to the stroke chamber under hydraulic pressure, and a suction in step b2) comprises a pressureless supply of hydraulic fluid from the reservoir, in particular suction tank. During inflow, the pressure or hydraulic pressure is preferably less than the system pressure, whereby the respective prevailing or applied hydraulic pressure may be regulated or controlled essentially in any way, in particular in the range from very low pressures to the system pressure, in particular from unpressurized to the system pressure.
By controlling or regulating the first and/or second hydraulic valve, the volume flow of the hydraulic fluid from or to the stroke chamber is controlled or regulated, and, based on the controlled or regulated volume flow, the speed and/or position of the bear during the working stroke or return stroke is adjusted, in particular controlled or regulated.
The first and/or second hydraulic valves are regulated or controlled and/or the starting position is selected so that the bear continues to move at an essentially constant speed after reaching the target speed until the start of a forming process and/or so that the forming speed is reached at the time of forming.
A controllable hydraulic valve is used as the first and/or second hydraulic valve, preferably a continuous directional control valve, a proportional directional control valve, a servo directional control valve and/or a control directional control valve.
The first and/or second hydraulic valve is/are regulated or controlled in a movement phase or lifting phase after reaching the target speed such that the hydraulic pressure in the stroke chamber corresponds to a predetermined or predeterminable hydraulic pressure or pressure range, wherein the predetermined or predeterminable pressure or pressure range is preferably between 2 to 6 bar, more preferably between 3 to 4 bar. By means of a corresponding control and/or regulation, the hydraulic pressure can be set so that it is essentially always above the cavitation pressure of the hydraulic fluid in the hydraulic system.
The first and/or second hydraulic valve is/are dynamically regulated or controlled based on a table of values for positions, speeds and/or target speeds of the bear, and/or for pressure curves in the stroke chamber, and/or dynamically regulated or controlled based on determined position and/or speed data of the bear.
Determined position and/or speed data or curves of the bear and/or pressure curves of the hydraulic pressure in the stroke chamber and/or return stroke chamber are monitored and/or stored in a memory unit.
The first and/or second hydraulic valve and a resulting volume flow of hydraulic fluid are regulated or controlled such that the time period until the target speed is reached is maximized while minimizing the time period of the movement phase after the target speed is reached, wherein, optionally, the movement phase spans between 5% to 15%, preferably about 10% of the stroke of the hydraulic cylinder.

The process-sided embodiments provide analogous advantages to those of the forming machine and the hydraulic control unit. In particular, a comparatively simple design can be achieved with safe operation at the same time.

During operation of the forming machine, specific tools for the respective forming task are usually coupled to the bear or ram, which, when acting on a workpiece to be formed, form the workpiece at the end of a working stroke or press stroke.

In particular, the hydraulic cylinder may be a double-acting hydraulic cylinder, such as a differential cylinder.

A working stroke is understood in particular to be an operation of the hydraulic cylinder that results in a forming operation. A return stroke is understood in particular to be an operation of the hydraulic cylinder in which the piston or bear is moved back, for example to an initial position intended for the execution of a subsequent working stroke. The starting positions of successive working strokes may or may not be identical. The working stroke and return stroke can be carried out cyclically, with the hydraulic valves being actuated cyclically accordingly.

The term hydraulic circuit as used herein is to be understood in particular in a general sense. In particular, the term hydraulic circuit is intended to include not only hydraulic lines, but also, depending on the context, additional parts and components such as control units, control units, valves, pumps, pressure transducers, hydraulic cylinders, control blocks, etc., which are present or required for the hydraulic operation of the hydraulic cylinder.

The hydraulic valves referred to herein are in particular valves with an adjustable variable volume flow, i. e. in which the volume flow is adjustable, in particular controllable or adjustable. Such a valve differs from a conventional open-close valve with only two selectable switching positions in that several, for example a plurality of switching positions can be specifically controlled or regulated. In particular, the hydraulic valves referred to herein may be designed in such a way that the volume flow is essentially continuously or continuously adjustable and that the opening state of the valve, in particular the opening width and/or the opening time, can be specifically adjusted, in particular controlled or regulated, e. g. over time according to a function of time or as a function of other variables. In particular, controllable valves that allow the volume flow rate or the opening width and/or opening time to be adjusted in terms of control and/or regulation are suitable.

In particular, the hydraulic circuit may be set up to adjust and vary, in particular to control or regulate, the volume flow of the hydraulic valve(s) as a function of a target speed of the bear to be achieved in an acceleration phase of the working stroke. For example, the hydraulic circuit can be set up to adjust the volume flow, for example the opening width and/or the opening duration of the hydraulic valve(s) over time so that the target speed is reached within a predetermined or predeterminable stroke range of the piston. For setting and varying, in particular controlling or regulating the volume flow, a corresponding control unit, in particular a control unit or regulating unit, can, for example, use data stored in a table of values, which specify the volume flows and/or hydraulic pressures to be set over time for the respective operating conditions and operating parameters, such as forming machine, type of jaw, jaw weight, tool height, tool weight, type of forming, type of material, etc., in order to achieve the desired target speed, and/or from which the control unit can determine and/or dynamically regulate or control the volume flows to be set.

The suction tank or return tank is preferably an unpressurized reservoir for hydraulic fluid.

In the case of a vertically operated bear, in which the working stroke takes place vertically downwards, the weight of the piston, the piston rod, the bear and any components attached to it, such as tools, has an accelerating effect. Consequently, in such vertically operating forming machines, the forming machine or the hydraulic control unit may be set up to switch the hydraulic valves once the target speed has been reached, so that the desired speed for forming is achieved. On the one hand, the restoring forces generated by the system pressure in the first cylinder chamber or the lifting chamber act on the piston and, on the other hand, the weight of the piston, piston rod bear, etc. and the stroke forces resulting from the pressurization of the second cylinder chamber or the stroke chamber.

If the second cylinder chamber is depressurized after reaching the target speed, the restoring force of the first cylinder chamber and the weight force essentially act on the piston. In order for a return stroke to occur, the restoring force must be greater than the weight force. If an operating mode with depressurization of the second cylinder chamber results in a restoring force after reaching the target speed, the target speed can be set higher than the forming speed in order to achieve a predetermined forming speed at the time of forming, so that the forming speed is achieved in the movement phase resulting after reaching the target speed. The force resulting from the restoring force and the weight force and counteracting the movement can be taken into account when setting the target speed, in particular in such a way that the target speed is set to the forming speed by the counteracting force from depressurization when the forming position is reached.

Preferably, the forming machine is operated in such a way that the target speed is reached shortly before or immediately before the forming position or the forming point, so that any reduction in speed caused by depressurization is negligible, i. e. the target speed is essentially maintained.

Setpoint tables or (setpoint) functions can be determined for position, speed and/or hydraulic pressure under given boundary conditions, including e. g. mass of the bear and thus moving components, stroke of the hydraulic cylinder, type of hydraulic fluid (viscosity etc.) etc., by test or trial runs and/or by simulation. The setpoint tables or (setpoint) functions may, for example, be or become stored in an electronic memory of the forming machine and made available to a control unit or regulation unit for the temporal control or regulation of the hydraulic valves.

The pressure accumulator may, for example, be fed by a pump unit that applies the system pressure to the hydraulic circuit and the pressure accumulator.

The hydraulic valves are actuators that can be formed, for example, in the form of controllable or adjustable valves and/or pumps with a controllable or adjustable motor, as a controllable or adjustable unit. The actuators may, for example, be selected from the group comprising continuous directional control valves, proportional directional control valves, servo directional control valves, control directional control valves and servo pumps. The use of the actuators mentioned enables the implementation of advantageous, in particular relatively short, actuating times for positioning and varying the volume flows, and in particular a comparatively precise and/or repeatable execution of a movement cycle consisting of working stroke, forming and return stroke for workpiece forming. With actuators of this type, comparatively short actuating times and comparatively fast reaction and response times can be achieved, whereby cavitations can be at least largely or even completely avoided.

A control may be based on a predetermined or predeterminable hydraulic pressure, hydraulic pressure interval and/or a predetermined or predeterminable temporal or local hydraulic pressure curve as a reference variable. For example, the hydraulic pressure or its course can be predetermined or presettable for the time interval of a working stroke or return stroke or for the position of the bear or the piston of the hydraulic cylinder during a working stroke or return stroke.

Corresponding hydraulic pressures and/or curves may be obtained, for example, from a test operation of the forming machine and/or from simulations.

An optimization of the movement sequence of the hydraulic cylinder during a working stroke may, for example, provide that the suction phase or inflow phase corresponds in the range of 5% to 15%, preferably 10% of the stroke of the hydraulic cylinder. In particular, the volume flow for accelerating the bear can be set and varied in such a way that the time remaining after the acceleration phase until immediately before the forming process is greater than the setting, response and/or switching times of the hydraulic valves, or of the actuator in general. By setting and varying, i. e. controlling and/or regulating, the volume flows in the acceleration phase accordingly, the length of the acceleration phase and correspondingly the length of the inflow phase or the ratio thereof may be set, e. g. also depending on the target speed or forming speed to be achieved in each case.

For example, at low target speeds, the volumetric flow may be controlled or adjusted more slowly and with a smaller increase or smaller rate of change so that the target speed is reached in a late phase of the working stroke, e. g. in the last third of the working stroke. At high target speeds, the volume flow may be adjusted upwards correspondingly faster, for example so that the target speed is also reached in a late phase of the working stroke. It is also possible that the starting position or starting position of the piston for executing a working stroke is set as a function of the target speed. For example, starting positions that are closer to the first end can be selected for lower target speeds or forming speeds, and starting positions that are closer to the second end can be used for higher target speeds or forming speeds.

With the proposed forming machine and the hydraulic control, it is possible in particular to use only a partial stroke of the hydraulic cylinder for a working stroke to accelerate the bear, starting from a reversal point located in the movement sequence of the bear with zero bear speed, towards the target speed. Accordingly, it is possible to shift the starting position of the working stroke in the direction of the first end or to shorten the return stroke. The starting positions suitable for given target speeds can be obtained, for example, from test or trial runs and/or by simulation, and can be provided, for example, in the form of a table of values in a database of a control or regulation unit of the forming machine or the hydraulic circuit.

If the return stroke path is shortened, for example at comparatively low target speeds, it is possible to increase the frequency of forming machine forming operations and/or save energy by shortening the return stroke path.

In the proposed operation using the two hydraulic connections by adjusting and varying, in particular controlling or regulating, the volume flow to or from the cylinder chambers, e. g. depending on the target speed to be achieved, it is possible to shorten the inflow phase, whereby, for example, a calming of the hydraulic fluid in the reservoir, e. g. in the suction tank or return tank, may be achieved, so that smaller reservoirs may be used. Furthermore, the risk of cavitation in the phase after reaching the target speed may be reduced.

By adjusting and varying, in particular controlling or regulating, the volume flow into the second cylinder chamber or stroke chamber, it is possible in particular to adjust, in particular to control or regulate, the volume of hydraulic fluid flowing into the second cylinder chamber per unit of time and/or the time interval in which hydraulic fluid flows into the second cylinder chamber. It is therefore possible, for example, to adjust the opening width of the hydraulic valves and their opening time, in particular the filling time, in a targeted and variable manner. The volume flow can be set and/or varied, for example, by controlling or regulating the opening state of the hydraulic valves according to a function of the time and/or a function of the stroke or the stroke position. This makes it possible, for example, to adjust the duration of the acceleration phase to reach the target speed, in particular as a function of the target speed. In particular, it is possible to control or regulate the hydraulic valves at both low and high target speeds in such a way that the target speed is reached shortly before or immediately before the forming process, preferably in such a way that the duration of the inflow phase or suction phase is reduced to a minimum. As cavitations can occur in the suction phase in particular, minimizing the suction phase can achieve functionally reliable operation.

Embodiments of the invention are described in more detail below with reference to the attached figures. In which:

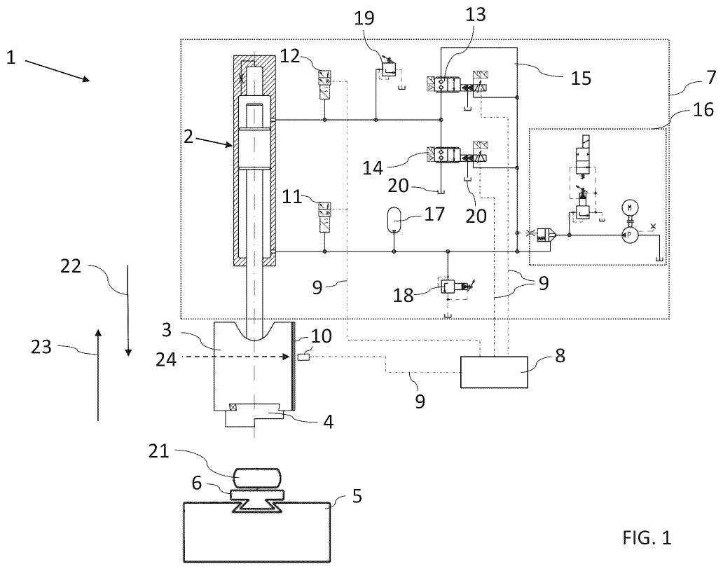

FIG. 1 schematically shows a forming machine, which may be a forging hammer, for example;

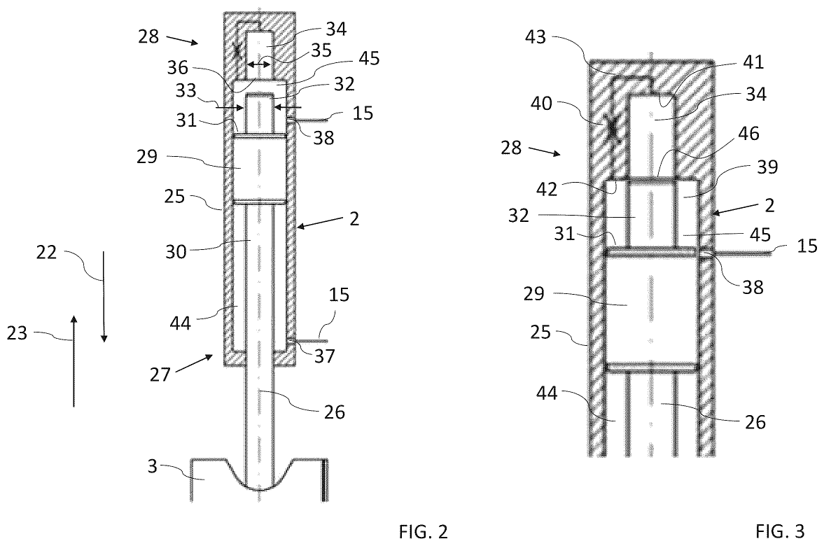

FIG. 2 shows an enlarged view of a hydraulic cylinder of the forming machine;

FIG. 3 shows an enlarged view of an upper end of the hydraulic cylinder;

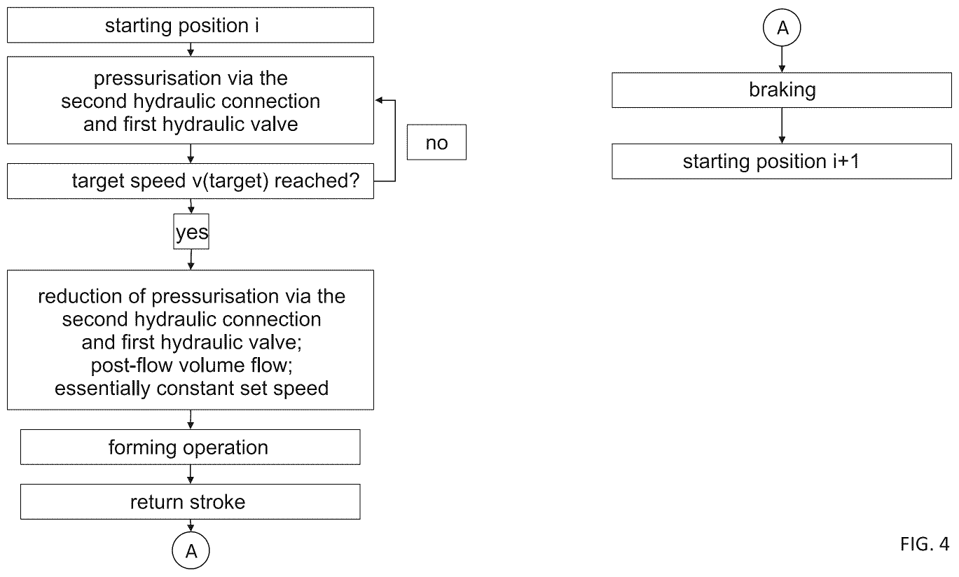

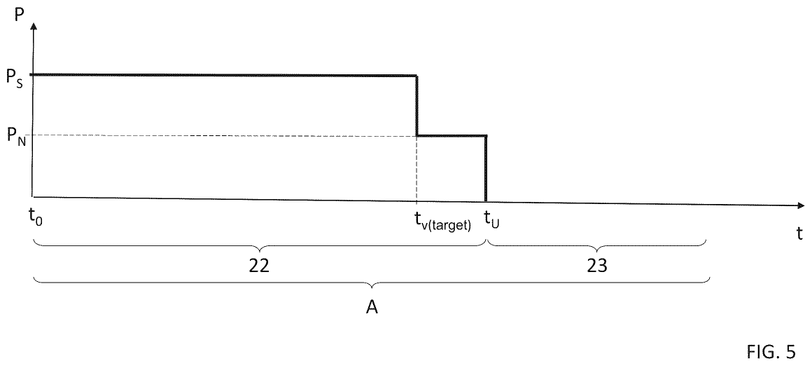

FIG. 4 a process sequence of a first variant of a forming cycle for the forming machine;

FIG. 5 shows an exemplary flow diagram for a working cycle with pressurized inflow phase;

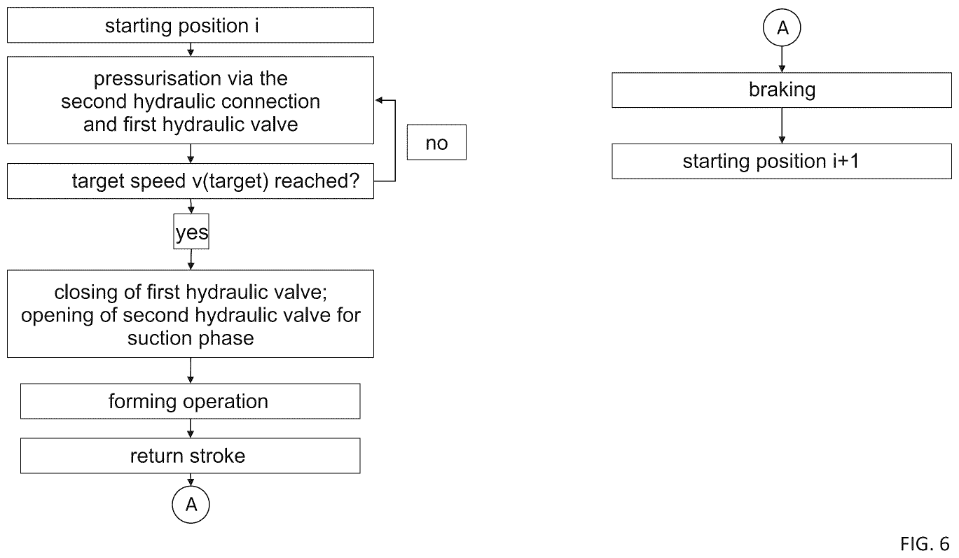

FIG. 6 shows a process sequence of a second variant of a forming cycle for the forming machine; and

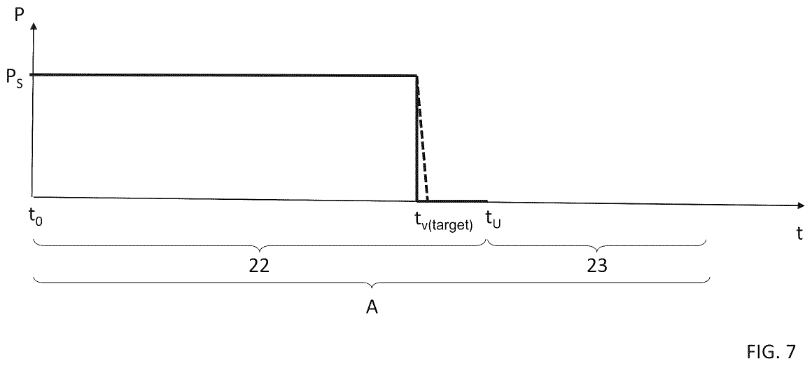

FIG. 7 shows an exemplary flow diagram for a working cycle with unpressurized suction phase.

FIG. 1 schematically shows a forming machine 1, which may be a forging hammer, for example.

The forming machine 1 comprises a hydraulic cylinder 2, a bear 3 with an upper die or swage 4, a lower die or swage 6 which is brought down on a shabot 5, and a hydraulic circuit 7. The forming machine 1 further comprises a control unit 8, for example a hydraulic control or regulation unit, with, for example, a processor and/or a programmable or programmed electronic unit.

The control unit 8 is connected via control lines and/or data lines 9 to a displacement measuring unit 10, which comprises, for example, a measuring sensor and an associated scale, to a first pressure transducer 11 and a second pressure transducer 12, to a first hydraulic valve 13 and a second hydraulic valve 14.

Apart from hydraulic lines 15, the hydraulic circuit 7 also comprises, in addition to the pressure transducers 11, 12 and the hydraulic valves 13, 14, a pump unit 16, a pressure accumulator 17 and a first safety valve 18 and second safety valve 19. Furthermore, at least one reservoir 20 for hydraulic fluid, in particular in the form of a suction tank and/or return tank, is provided.

The hydraulic forming machine 1 is intended for forming workpieces 21, whereby the forming is performed by the upper swage 4 and lower swage 6. Specifically, forming is performed by moving the bear 3 with the upper swage 4 attached to it in a working stroke 22 from an initial position 24 downwards to the lower swage 6. During operation of the forming machine 1, the working stroke 22 is followed by a return stroke 23, during which the bear 3 is moved to a starting position 24. The working stroke 22 and return stroke 23 with intermediate forming form a working cycle that can be repeated cyclically.

The hydraulic cylinder 2, which is shown enlarged in FIG. 2, comprises a cylinder tube 25 with a piston 29 movable therein along a longitudinal axis 26 between a first end 27 and a second end 28, which is coupled to a piston rod 30 extending in the direction of the first end 27 and coupled or couplable to the bear 3.

On the side 31 facing away from the piston rod 30, the piston 29 has a cylindrical rod extension 32 extending towards the second end 28, the outer diameter 33 of which is smaller than that of the piston 29. The rod extension 32 is coaxial to the piston 29 and to the piston rod 30 with respect to the longitudinal axis 26.

At the second end 28, the hydraulic cylinder 2 has a bore 34 coaxial with the rod extension 32 with respect to the longitudinal axis 25 and open towards the piston 29 or rod extension 32. The inner diameter 35 of the bore 24 essentially corresponds to the outer diameter 33 of the rod extension 32, so that the rod extension 32 can plunge into the bore 34. The bore 34 is formed in the manner of a blind hole, with an opening 36 oriented towards the cylindrical extension 32.

The hydraulic cylinder 2 or the cylinder tube 25 has a first hydraulic connection 37 in the region of the first end 27 and a second hydraulic connection 38 in the region of the second end 28.

The second hydraulic connection 38 is arranged or positioned such that the piston 29 closes the second hydraulic connection 38 during a movement towards the second end 28 when the rod extension 32 reaches or closes the bore 34, which is shown enlarged in FIG. 3.

In the operating state shown in FIG. 3, the bore 34 is connected to an annular space 39 formed around the rod extension 32 via a throttle 40, the throttle 40 being connected in the present case to a channel 43 extending between the base 41 of the bore 34 and a base-like shoulder 42 or annular shoulder at the second end 28 of the cylinder tube 25.

On the side of the piston rod 26 or in the region of the first end 27, the hydraulic cylinder 2 has a first cylinder chamber 44, and on the side of the rod extension 32 or in the region of the second end 28, the hydraulic cylinder 2 has a second cylinder chamber 45.

As can be seen from FIG. 2, the first cylinder chamber 44 is formed as an annular chamber, and as can be seen from the combined view of FIGS. 2 and 3, the second cylinder chamber 45 is an annular chamber only when the distal end 46 of the rod extension 32 closes or reaches the opening 36.

During operation of the hydraulic cylinder 2 for a forming operation of the workpiece 21, the second cylinder chamber 39 is pressurized with hydraulic fluid or hydraulic pressure in the working stroke 22, whereby the piston 29 is accelerated towards the first end 27. After the forming operation, the piston 29 is moved towards the second end 28 in the return stroke 23. If no deceleration of the moving mass formed by the piston 29, the piston rod 26, the rod extension 32, the bear 3 and the upper swage 4, and possibly other components coupled thereto, occurs during the return stroke 23, deceleration occurs at the latest when the distal end 46 of the rod extension 32 reaches the opening 36 of the bore 34.

When the distal end 46 of the rod extension 32 reaches the opening 36, the second hydraulic connection 38 is closed and the hydraulic fluid in the bore 34 and in the annular space 39 acts as a brake cushion for the moving mass. The throttle 40 equalizes the pressure between the hydraulic fluid in the bore 34 and the hydraulic fluid in the annular chamber 39, thereby improving the damping and braking characteristics.

However, the braking of the piston 29 or the moving mass by the interaction of the rod extension 32 and the bore 34 is not mandatory, because according to the invention, the control unit 8 may be set up in such a way that braking of the piston 29 or the moving masses can take place by controlling or regulating the hydraulic valves 13 and 14, which will be explained below using an exemplary forming cycle.

To this end, FIG. 4 shows a process sequence of a first variant of a forming cycle. FIG. 6 shows a process sequence of a second variant of a forming cycle for the forming machine. The process sequences are regulated or controlled by the control unit 8.

According to the variant according to FIG. 4, the piston 29 or bear 3 is positioned in the initial position or starting position 24, designated as starting position i in FIG. 4, at the start of a working stroke 22. When the working stroke 22, for example an impact, is triggered, the second cylinder chamber 45, or the stroke chamber, is pressurized with hydraulic fluid via the second hydraulic connection 38. The hydraulic pressure can correspond to the system pressure provided by the pump unit 16 or the pressure accumulator 17. For this purpose, the first hydraulic valve 13 is controlled or regulated by the control unit to an open position, for example (fully) open. The hydraulic pressure generated by the first hydraulic valve 13, preferably the system pressure, and the weight of the mass to be moved (piston 29, rod extension 23, piston rod 26, bear 3, upper swage 4), minus any friction losses, therefore act in the direction of the working stroke 22. In this phase, the bear 3, or more precisely the mass to be moved, is accelerated. The acceleration serves to accelerate the bear 3 to a target speed v(target). As long as the target speed v(target) is not reached, the pressurization is continued. The second hydraulic valve 14 is closed or controlled or regulated to the closed position.

If or when the target speed v(target) is reached, the control unit 8 intervenes in terms of control or regulation and controls or regulates the pressurization via the second hydraulic connection 38, specifically the open position of the first hydraulic valve 13, in such a way that the piston 29 continues to move at essentially constant speed, i. e. the target speed, and/or that the forming speed is reached. The determination of whether the target speed has been reached or whether the piston 29 or bear 3 continues to move at the target speed can be determined, for example, via speed or position data of the displacement measuring unit 10. In particular, the first hydraulic valve 13 can be closed further compared to the acceleration phase to reach the target speed v(arget), so that the hydraulic pressure present in the second cylinder chamber 45 is reduced compared to the system pressure. In the process, a pressurized post-flow volume flow is generated by the first hydraulic valve 13 or the second hydraulic connection 38. This counteracts the system pressure prevailing in the first cylinder chamber 44 with the weight of the moving mass. For this purpose, and otherwise during the entire forming cycle, the first hydraulic connection 37 is pressurized with the system pressure, e. g. from the pressure accumulator 17.

When the workpiece 21 is reached, the forming operation takes place, which is followed by the return stroke 23 after the hydraulic cylinder 2 has reached the lower reversal point or bottom dead center.

After the forming operation, which can be determined using speed and/or position data from the displacement measuring unit 10, for example, the return stroke 23 takes place. The hydraulic valves 13 and 14 are reversed or controlled accordingly. Specifically, the first hydraulic valve 13 is closed and the second hydraulic valve 14 is opened. As a result, the second hydraulic connection 38 is depressurized and connected to the reservoir 20, a return tank, so that there is no system-related hydraulic pressure in the second cylinder chamber 39. The system pressure present in the first cylinder chamber 44 accelerates the moving mass, in particular the bear 3, upwards, as a result of which the return stroke 23 takes place. As described above, since forming and the start of the return stroke follow each other in a comparatively short time (in the range of milliseconds) and/or due to system inertia, it is advantageous if the hydraulic valves are reversed before forming, or that the bear or the hydraulic cylinder is taken out of control shortly before forming, so that pressure peaks in the forming area are avoided during the return stroke. Please refer to the explanations above.

If the return stroke 23 takes place up to the second end 28, the piston 29 can be braked by the braking effect of the rod extension 32 and the bore 34. However, braking of the piston 29 can also be brought about by throttling the return flow of the hydraulic fluid via the second hydraulic connection 38 and the second hydraulic valve 14 by controlling or regulating the opening state of the second hydraulic valve 14 accordingly. In particular, the second hydraulic valve 14 can be increasingly closed so that the force required to displace the hydraulic fluid from the second cylinder chamber 39 increases. This creates a braking force that slows down the return stroke movement 23 of the piston 29. With suitable control or regulation of the opening state of the second hydraulic valve 14, it can be achieved that the return stroke movement ends at a desired starting position for executing a subsequent working stroke 22, wherein this starting position is designated i+1 in FIG. 4 and can, but does not have to, correspond to the starting position i when the preceding working stroke 22 is triggered. Depending on the forming requirements, it is possible, for example, that the two starting positions i and i+1 differ from each other. Due to the possibility of controlling or regulating the return stroke 23 via the second hydraulic valve 14, the starting position i+1 reached after the return stroke 23 can deviate from the reversal point or dead center at the second end 28 (see illustration of FIG. 3), and can be at a substantially arbitrary position between the first end 27 and the second end 28.

In particular, the starting position 24 can be selected depending on the target speed to be achieved. This is possible in particular because the pressurization of the second cylinder chamber 45 can be controlled or regulated via the first hydraulic valve 13. For example, the starting position 24 can be selected or set in such a way that the target speed v(target) is reached with the respectively selected pressurization, for example with system pressure, on the piston stroke remaining from the starting position 24, preferably in such a way that the time remaining from reaching the target speed v(target) until forming is optimized, in particular minimized. For example, the starting position 24 and the pressurization in the acceleration phase can be set so that the target speed v(target) is reached immediately before forming.

FIG. 5 shows an exemplary progression diagram for a working cycle A with pressurized inflow phase via the first hydraulic valve 13 after reaching the target speed. The time t is plotted on the abscissa and the hydraulic pressure P supplied to the first cylinder chamber 45 via the second hydraulic connection 38 and the first hydraulic valve 13 is plotted on the ordinate. At the start of the working cycle A at to, the first hydraulic valve 13 is controlled or regulated into the open position so that the system pressure P_{S} is present in the first cylinder chamber 45. This system pressure P_{S} is maintained until the bear 3 has reached the target speed v(target) at a time t_{v(target)}. At the time t_{v(target)}, the forming point is not yet reached, and the opening state of the first hydraulic valve 13 is controlled or regulated such that the first cylinder chamber 45 is pressurized with an inflow pressure P_{N} to generate an inflow volume flow, wherein the inflow pressure P_{N} is less than the system pressure P_{S}. The inflow pressure P_{N} is set or controlled or regulated, for example, such that the piston 29 is in force equilibrium, i. e. such that the target speed v(target) reached is maintained. At or shortly before the forming time t_{U}, the first hydraulic valve 13 is closed. Up to this point in time, the second hydraulic valve 14 is closed in the process variant according to FIG. 4, and the system pressure P_{S} is present in the first cylinder chamber 44.

For the return stroke R or already during forming, the second hydraulic valve 14 is controlled or regulated in the open position so that the second cylinder chamber 45 is connected to the return tank without pressure. After forming, the system pressure P_{S} in the first cylinder chamber 44 results in a restoring force that causes the return stroke 23.

During the return stroke 23, the second hydraulic valve 14 can initially be fully open, and can be regulated or controlled into the closed position in the further course of time in such a way that the piston 29 is positioned at a predetermined starting position for a subsequent working stroke 22. If the second hydraulic valve 14 is not closed or controlled, the moving mass is braked at the latest by the rod extension 32 and bore 34 and by the annular space 39 after the piston 29 closes the second hydraulic connection 38.

In contrast to the course shown in FIG. 5, the course of the hydraulic pressure P provided via the first hydraulic valve 13 can be different, whereby this can, for example, decrease continuously or gradually. The course of the hydraulic pressure P can be set essentially as desired on the basis of the controllable or adjustable first hydraulic valve 13, preferably in such a way that cavitations are avoided and the target speed v(target) is safely achieved. The control or regulation can, for example, be based on a predetermined pressure curve, which can be determined from test runs and/or simulation, for example.

FIG. 6 shows a process sequence of a second variant of a forming cycle for the forming machine 1.

According to the variant according to FIG. 6, the piston 29 or bear 3 is positioned in the starting position or starting position 24, designated as starting position i in FIG. 6, at the start of a working stroke 22. When the working stroke 22 is triggered, for example an impact, the second cylinder chamber 45, or stroke chamber, is pressurized with hydraulic fluid via the second hydraulic connection 38. The hydraulic pressure P can correspond to the system pressure P_{S}, which is provided by the pump unit 16 or the pressure accumulator 17. For this purpose, the first hydraulic valve 13 is controlled or regulated into an open position by the control unit 8. The hydraulic pressure P, in particular the system pressure P_{S} and the weight of the mass to be moved (piston 29, rod extension 23, piston rod 26, bear 3, upper swage 4) minus any friction losses, therefore act in the direction of the working stroke 22. In this phase, the bear 3, or more precisely the mass to be moved, is accelerated. The acceleration serves to accelerate the bear 3 to a target speed v(target). As long as the target speed v(target) is not reached, the pressurization is continued. The second hydraulic valve 14 is closed or controlled or regulated to the closed position.

If or when the target speed v(target) is reached, the control unit 8 intervenes in terms of control or regulation and controls or regulates the first hydraulic valve 13 to the closed position and the second hydraulic valve to an open position. As a result, the second cylinder chamber 45 is connected without pressure to the reservoir 20, a suction tank, from which hydraulic fluid is sucked in via the second hydraulic valve 14 and the second hydraulic connection 38. Determining whether the target speed v(target) has been reached can be carried out in the same way as in the first variant.

Due to the pressureless suction, the moving mass can continue to move at the target speed v(target), so that this is essentially maintained. If the system causes the moving mass to slow down due to suction, this reduction is usually negligible, so that the target speed v(target) is essentially maintained and/or the desired forming speed is achieved. For this purpose, it is particularly advantageous if the acceleration phase is set so that the target speed v(target) is only reached shortly before or immediately before forming, so that any deceleration of the moving mass (e. g. by 0.2 m/s, see above) is negligible. It is also possible to include any decelerations, in particular in such a way that the target speed is increased by the deceleration value so that the desired forming speed is present at the forming point.

The first hydraulic connection 37 is pressurized with the system pressure P_{S}, e. g. from the pressure accumulator 17, and also during the entire forming cycle, in particular during the return stroke 23.

When the workpiece 21 is reached, the forming operation takes place, which is followed by the return stroke 23 after the hydraulic cylinder 2 has reached the lower reversal point or bottom dead center.

After the forming operation, which can be determined, for example, via speed and/or position data of the displacement measuring unit 10, the return stroke 23 takes place, with the first hydraulic valve 13 remaining in the closed position and the second hydraulic valve 14 being controlled and/or regulated into the open position or remaining in the open position. As a result, the second hydraulic connection 38 is connected without pressure to the reservoir 20, in particular a return tank, so that no system-related hydraulic pressure P is present in the second cylinder chamber 39. The system pressure P_{S} present in the first cylinder chamber 44 accelerates the moving mass, in particular the bear 3 upwards, and causes the return stroke 23.

The deceleration of the bear 3 or the moving mass and the setting of an initial position i+1 or starting position for a subsequent working stroke 22 can be carried out analogously to the variant according to FIG. 4. Reference is made to the explanations above.

An advantage of this variant can be that the transfer of the first hydraulic valve 13 to the closed position and the transfer of the second hydraulic valve 14 to an open position for suction overlap, in particular to avoid stalls in the hydraulic fluid.

FIG. 7 shows an exemplary progression diagram for a working cycle A with unpressurized suction phase via the second hydraulic valve 14 after reaching the target speed v(target). The time t is plotted on the abscissa and the hydraulic pressure P supplied to the first cylinder chamber 45 via the second hydraulic connection 38 and the first hydraulic valve 13 is plotted on the ordinate. At the start of the working cycle A at to, the first hydraulic valve 13 is controlled or regulated into the open position, so that the system pressure P_{S} is present in the first cylinder chamber 45, by means of which the acceleration of the bear 3 takes place. This system pressure P_{S} is maintained until the bear 3 has reached the target speed v(target) at a point in time t_{v(target)}. At the time t_{v(target)}, the forming point has not yet been reached and the first hydraulic valve 13 is controlled and/or regulated in the closed position. Furthermore, the second hydraulic valve 14 is opened so that the second cylinder chamber 45 is connected to the reservoir 20, in particular a suction tank, without pressure. Via the second hydraulic connection 38 and the second hydraulic valve 14, the continued movement of the piston 29 results in an unpressurized suction volume flow through which the moving mass can continue to move essentially at the target speed reached. The system pressure P_{S} is present throughout the first cylinder chamber 44.

The dashed line at t_{v(target)} shown in FIG. 7 corresponds to a variant in which the opening state of the first hydraulic valve 13 and that of the second hydraulic valve 14 overlap when the hydraulic valves are reversed or controlled at t_{v(target)}. As already mentioned, such an overlap is advantageous for avoiding flow stalls.

The return stroke takes place as in the variant according to FIG. 5, whereby here the first hydraulic valve 13 is already closed and the second hydraulic valve 14 is already open. The system pressure Pₛ present in the first cylinder chamber 44 counteracts the weight of the moving mass and thus causes the return stroke 23. With regard to the return stroke 23, reference is made to the explanations for FIG. 5, which apply analogously here.

By minimizing the time between reaching the target speed v(target) and forming, the inflow phase or suction phase is shortened or minimized. Since the transition from the acceleration phase to reach the target speed to the inflow phase or suction phase and the inflow or suction phases are comparatively susceptible to the occurrence of cavitations, the probability of cavitations occurring can at least be reduced by minimizing the inflow phases or suction phases. With suitable control or regulation, cavitations can even be completely avoided, or at least avoided as far as possible.

To avoid cavitation, it is possible for the control unit 8 to detect the hydraulic pressure P in the hydraulic circuit 7 via the pressure transducers 11 and 12 and to control or regulate the hydraulic valves 13, 14 in such a way that the hydraulic pressure P prevailing in the hydraulic circuit, in particular in the second cylinder chamber 45, is always above the cavitation pressure of the hydraulic fluid.

The acceleration phase to reach the target speed v(target) and the subsequent inflow phase or suction phase can be set up so that the hydraulic pressure in the hydraulic circuit is always above the cavitation pressure of the hydraulic fluid. For this purpose, the control or regulation of the volume flows makes it possible to adjust them, for example on the basis of test runs and/or simulation, so that the working stroke and/or return stroke can be carried out without cavitation. Parameters for setting the working stroke and/or return stroke are, in particular, the level of the hydraulic pressure during acceleration, the progression of the hydraulic pressure P over time during acceleration, the duration of the acceleration phase until the target speed v(target) is reached, the suction volume flow and the suction volume flow. These parameters can be controlled or regulated via the first and second hydraulic valves 13, 14.

Overall, it can be seen that the problem underlying the invention is solved.

In particular, the underlying invention also has the following advantages or beneficial effects:

Only two hydraulic connections are required on the hydraulic cylinder to carry out a work cycle, i. e. the lower first hydraulic connection and the upper second hydraulic connection.

The upper or second hydraulic connection is used for both the working stroke and the return stroke.

The lower or first hydraulic connection can be pressurized with system pressure P_{S} throughout, so that no control or regulation is required in this respect.

The rod extension, which may be part of the piston rod, for example, if it passes through the piston, for example, and the bore at the first end, in particular at the upper end of the cylinder tube above the piston, can be used to decelerate the moving mass, in particular as an emergency brake, for example in the event of failure of the control or regulating electronics.

The moving mass can be braked during the return stroke advantageously via the rod extension and the bore, or alternatively by controlling or regulating the second hydraulic valve, i. e. the return flow into the return stroke tank. No additional brake throttles are required, as in known forming machines or forging hammers, via which the hydraulic fluid remaining in the upper cylinder chamber must be discharged to achieve a braking effect.

The proposed forming machine or hydraulic control system enables flexibly adjustable starting positions or starting positions for the working stroke and is therefore not limited to just one top dead center.

The proposed forming machine or hydraulic control system enables a correct approach to the variable top dead center, i. e. the starting position for the next stroke, if, for example, the displacement measuring unit or a displacement measuring system is used for position monitoring. The hydraulic valves can also be controlled or regulated on the basis of speed data or pressure data, so that the acceleration phase can be optimized and/or controlled or regulated according to predetermined position, speed and/or pressure curves or curves.

The proposed forming machine or hydraulic control does not require a separate suction valve like conventional forming machines or forging hammers.

The proposed forming machine or hydraulic control system allows a certain degree of flexibility with regard to the control or regulation of the hydraulic valves for the phase of the working stroke after the target speed has been reached.

In particular, on the one hand, operation is possible in which hydraulic fluid is sucked in without pressure via the second hydraulic valve once the target speed has been reached, and on the other hand, operation is possible in which hydraulic fluid flows in via the first hydraulic valve based on pressure once the target speed has been reached. Depending on the requirements for the working stroke, one or the other variant can be selected, which is particularly advantageous with regard to different forming operations and/or avoiding stalls and/or cavitations.

It is possible to optimize the acceleration phase and/or the suction phase or inflow phase, in particular with regard to the time sequence and its duration. For optimization, the acceleration phase can be variably controlled or regulated via the first hydraulic valve and the subsequent suction phase or inflow phase via the second or first hydraulic valve. In particular, as already mentioned, no separate suction valve is required for the suction phase.

The first hydraulic valve can be used as an impact valve, and the second hydraulic valve can be used both as a suction valve and as a lifting valve for the return stroke in the variant with suction.

In particular, the forming machine or hydraulic control system enables a working cycle in which the working cycle is initiated by opening the first hydraulic valve. Once the desired target speed has been reached, the first hydraulic valve can be closed and the second hydraulic valve opened, whereby a covering phase can be integrated between opening the second hydraulic valve and closing the first hydraulic valve due to the control or regulation, so that the hydraulic fluid flow does not break off. Suction can take place via the second hydraulic valve up to forming, with subsequent return stroke via the second hydraulic valve.

The different variants concerning suction, e. g. from a suction tank or container, and inflow, e. g. from the pressure accumulator, enable operating modes in which hydraulic oil comes from the suction tank without pressure (suction phase) or is sucked from it, and in which hydraulic oil is supplied in a pressure-based manner controlled or regulated via the first hydraulic valve. The hydraulic oil for inflow can be supplied based on the hydraulic pressure provided by the pressure accumulator.

Overall, the proposed forming machine, the proposed hydraulic control system and the proposed method enable a comparatively simple design with flexible control or regulation of the work cycle, whereby safe operation can be provided by the rod extension and the bore.

### LIST OF REFERENCE SYMBOLS

1 Forming machine
2 Hydraulic cylinder
3 Bear
4 Upper swage
5 Shabot
6 Lower swage
7 Hydraulic circuit
8 Control unit
9 Control/data line
10 Displacement measuring unit
11, 12 First and second pressure transducer
13, 14 First and second hydraulic valve
15 Hydraulic line
16 Pump unit
17 Pressure accumulator
18, 19 Safety valve
20 Reservoir
21 Workpiece
22 Working stroke
23 Return stroke
24 Starting position
25 Cylinder tube
26 Longitudinal axis
27 first end
28 Second end
29 Pistons
30 Piston rod
31 Side facing away from the piston rod
32 Rod extension
33 Outer diameter
34 Bore
35 Inner diameter
36 Opening
37 First hydraulic connection
38 Second hydraulic connection
39 Annular space
40 Throttle
41 Floor
42 Shoulder
43 Channel
44 First cylinder chamber
45 Second cylinder chamber
46 distal end
A Work cycle
v(target) Target speed
t time
P_{S} System pressure
P_{N} Inflow pressure

1-17. (canceled)

18. Hydraulic forming machine, in particular an impact forming machine, preferably a forging hammer, for forming a workpiece, comprising
a hydraulic cylinder with a piston guided in a cylinder tube, which divides the cylinder tube into a first cylinder chamber through which a piston rod coupled to a bear passes, and into a second cylinder chamber, wherein the first cylinder chamber has a first hydraulic connection and the second cylinder chamber has a second hydraulic connection
a hydraulic circuit with a control unit for controlling and/or regulating the operation of the hydraulic cylinder, wherein the hydraulic circuit comprises a first hydraulic valve which is coupled to the control unit in terms of control technology, is preferably designed as a proportional valve and is connected to the second cylinder chamber via the second hydraulic connection,
wherein:
the control unit is set up to regulate and/or control an opening width of the first hydraulic valve during execution of a working stroke intended for forming a workpiece in such a way that
the first hydraulic valve is opened in a first phase and the bear is accelerated to a target speed in the first phase,
in a second phase following the first phase, the opening width of the first hydraulic valve is reduced to an inflow opening width, and
the first hydraulic valve is closed during a return stroke that runs in the opposite direction to the working stroke.

19. Hydraulic forming machine according to claim 18, wherein the hydraulic circuit further comprises a second hydraulic valve which is connected to the second hydraulic connection, and wherein the control unit is set up to control an opening width of the second hydraulic valve, which is preferably designed as a proportional valve, in such a way that an initial position of the bear for a subsequent working stroke can be variably set when a return stroke is performed in the opposite direction to the working stroke.

20. Hydraulic forming machine according to claim 18, further comprising a measuring unit for determining the position of the bear, wherein the control unit is set up to determine one or more operating parameters, such as an initial position and/or a target speed and/or an impact energy of the bear for a subsequent working stroke, on the basis of a forming position determined by the measuring unit for a preceding working stroke, wherein, preferably, an initial working stroke is set up as a set-stroke executed at minimum impact energy.

21. Hydraulic forming machine according to claim 18, wherein the control unit is set up to control the opening width of the first hydraulic valve on the basis of a variably predeterminable and/or determinable starting position and/or a variable forming position, in particular a variably predeterminable and/or determinable forming position, in particular in such a way that the working stroke, in particular a forming stroke, can be executed with a respectively suitable, preferably predetermined, in particular respectively maximum available, impact energy.

22. Hydraulic forming machine according to claim 18, wherein the control unit is set up to variably adjust an initial position for executing a working stroke, in particular as a function of at least one operating parameter of the hydraulic cylinder with respect to one or more preceding working strokes, wherein the operating parameter is preferably an operating parameter detected by one or more sensor units.

23. Hydraulic forming machine according to claim 18, wherein the control unit is set up to determine an initial position for a working stroke at a predetermined forming energy and to set it by controlling and/or regulating the second hydraulic valve during a return stroke, wherein the control unit is preferably set up to variably set the initial position on the basis of a free path length of the bear between the initial position and the forming position of a preceding working stroke.

24. Hydraulic forming machine, in particular according to claim 18, preferably forging hammer, set up for workpiece forming, comprising a hydraulic circuit with a unit for generating a predetermined system pressure for the hydraulic fluid and at least one reservoir for hydraulic fluid and comprising a hydraulic cylinder with a cylinder tube with a piston movable therein between a first and a second end, which is coupled to a piston rod extending in the direction of the first end and coupled or couplable to a bear, wherein the piston divides the cylinder tube into a first and second cylinder chamber and has, on the side facing away from the piston rod, a rod extension which extends towards the second end and whose outer diameter is smaller than that of the piston, wherein the hydraulic cylinder has at the second end a bore coaxial with the rod extension and open towards the piston, the inner diameter of which corresponds substantially to the outer diameter of the rod extension, so that the rod extension can plunge into the bore, and wherein the hydraulic cylinder and the cylinder tube comprises a first hydraulic connection in the region of the first end and a second hydraulic connection in the region of the second end, which is arranged in such a way that the piston closes the second hydraulic connection during a movement towards the second end when the rod extension reaches the bore.

25. Hydraulic forming machine, according to claim 18, wherein:
the first hydraulic connection is connected or can be connected to the hydraulic circuit, so that the first cylinder chamber of the hydraulic cylinder connected to the first hydraulic connection and downstream thereof is connected or can be connected to system pressure, in particular a pressure accumulator, and/or
wherein the hydraulic circuit comprises a valve unit connected or connectable to the second hydraulic connection, wherein the hydraulic circuit and the valve unit are arranged such that the second cylinder chamber of the hydraulic cylinder connected to the second hydraulic connection can be selectively acted upon at least temporarily with hydraulic pressure via the valve unit or can be connected at least temporarily without pressure to the reservoir when performing a working stroke.

26. Hydraulic forming machine according to claim 18, wherein the first hydraulic valve is arranged to assume a closed position at least temporarily during the working stroke and/or at least temporarily during a return stroke, preferably substantially during the entire return stroke, and wherein the second hydraulic valve is arranged to connect the second cylinder chamber to the reservoir without pressure when the first hydraulic valve is in the closed position.

27. Hydraulic forming machine according to claim 24, wherein the control unit is set up, in particular programmed for this purpose, such that:
a) during the working stroke, to control or regulate the first hydraulic valve into an open position, in which the second cylinder chamber is or is acted upon by hydraulic pressure via the first hydraulic valve until a predetermined target speed of the bear is reached, and at the same time to control or regulate the second hydraulic valve into a closed position,
b) during the working stroke and after or when the target speed is reached
b1) to control or regulate the first hydraulic valve into a closed position, and by controlling or regulating the second hydraulic valve into an open position, to connect the second cylinder chamber via the second hydraulic valve and/or via a suction valve to the reservoir, in particular a suction tank, and to generate a suction volume flow into the second cylinder chamber, with which the target speed is essentially maintained and/or a predetermined forming speed is achieved at the forming time; or
b2) by controlling or regulating the open position of the first hydraulic valve via the first hydraulic valve and/or via a suction valve, to generate an inflow volume flow into the second cylinder chamber, with which the target speed is essentially maintained and/or with which a predetermined forming speed is achieved at the forming time, the second hydraulic valve preferably being controlled or regulated into the closed position;
c) to control or regulate the second hydraulic valve connected to the second hydraulic connection to the open position and the first hydraulic valve connected to the second hydraulic connection to the closed position during a return stroke following the working stroke;
and, optional,
d) at least at the beginning of a further working stroke following the return strok, the first and second hydraulic valves are reversed or regulated in such a way that the first hydraulic valve is in an open position and the second hydraulic valve is in the closed position, wherein
e) during the working stroke and the return stroke, the first cylinder chamber is pressurized with the system pressure via the first hydraulic connection.

28. Hydraulic forming machine according to claim 18, wherein
the forming machine further comprises a displacement measuring unit for detecting the position and/or speed of the piston, the piston rod and/or the bear
and/or
wherein the hydraulic circuit further comprises at least one, preferably two pressure transducers, wherein a first pressure transducer is set up to detect the hydraulic pressure in the first cylinder chamber and a second pressure transducer is set up to detect the hydraulic pressure in the second cylinder chamber.

29. Hydraulic forming machine according to claim 24, wherein
the volume of the bore is connected to the volume of the second cylinder chamber via a throttle, so that the bore is connected to the second cylinder chamber via the throttle, in particular when the second hydraulic connection is closed by the piston
and/or
a diameter of the bore is larger than a diameter of the rod extension, such that an annular gap formed by a difference in diameter between the bore and the rod extension acts as a throttle to decelerate the piston.

30. Hydraulic control unit for operating, in particular for controlling or regulating, a hydraulic forming machine according to claim 18, comprising a processor and/or control electronics or control electronics which is or are set up to control or regulate the opening width of the first hydraulic valve when a working stroke intended for forming a workpiece is executed, in particular in such a way that
the first hydraulic valve is opened in a first phase and the bear is accelerated to a target speed in the first phase,
in a second phase following the first phase, the opening width of the first hydraulic valve is reduced to a predetermined inflow opening width, and
the first hydraulic valve is closed during a return stroke that runs in the opposite direction to the working stroke.

31. Hydraulic control unit according to claim 30, wherein
the hydraulic circuit further comprises a second hydraulic valve which is connected to the second hydraulic connection, and wherein the hydraulic control unit is arranged to control an opening width of the second hydraulic valve, which is preferably designed as a proportional valve, in such a way that, in the event of a return stroke taking place in the opposite direction to the working stroke, an initial position of the bear for a subsequent working stroke can be variably adjusted and/or
the forming machine further comprises a measuring unit for determining the position of the bear, wherein the hydraulic control unit is set up to determine one or more operating parameters, such as an initial position and/or a target speed and/or an impact energy of the bear, for a subsequent working stroke on the basis of a forming position determined by the measuring unit for a preceding working stroke, wherein, preferably, an initial working stroke is set up as a set-stroke carried out at minimum impact energy, and/or
the hydraulic control unit is set up to control the opening width of the first hydraulic valve on the basis of a variably predeterminable and/or determinable starting position and a variable forming position, in particular a variably predeterminable and/or determinable forming position, in particular such that the working stroke, in particular a forming stroke, can be executed with a respectively suitable, preferably predetermined, in particular respectively maximum available, impact energy and/or.
the hydraulic control unit is set up to variably adjust an initial position for executing a working stroke, in particular as a function of at least one operating parameter of the hydraulic cylinder with respect to one or more preceding working strokes, the operating parameter preferably being an operating parameter detected by one or more sensor units, and/or
the hydraulic control unit is set up to determine an initial position for a working stroke at a predetermined forming energy and to adjust it by controlling and/or regulating the second hydraulic valve during a return stroke, the hydraulic control unit preferably being set up to variably adjust the initial position on the basis of a free path length of the bear between the initial position and the forming position of a preceding working stroke.

32. Hydraulic control unit according to claim 30, wherein the hydraulic control unit is further arranged to determine a position and/or speed of the piston, the piston rod and/or the bear via a displacement measuring unit, and to control or regulate the first and/or second hydraulic valve as a function of the determined position and/or speed, preferably according to a predetermined or predeterminable position and/or speed curve.

33. Hydraulic control unit according to claim 30, wherein the hydraulic control unit is furthermore set up to determine the hydraulic pressure prevailing in the first and/or second cylinder chamber by means of a first or second pressure transducer, and to control and/or regulate the first and/or second hydraulic valve as a function of the determined hydraulic pressure, in particular according to a predetermined pressure curve and/or in such a way that the hydraulic pressure in the hydraulic circuit, in particular in the second cylinder chamber, is essentially above the cavitation pressure of the hydraulic fluid.

34. Method for operating, in particular for controlling or regulating, a hydraulic cylinder of a hydraulic forming machine, in particular according to claim 18,
control and/or regulation of the opening width of the first hydraulic valve by the control unit during execution of a working stroke provided for forming a workpiece in such a way that
the first hydraulic valve is opened in a first phase and the bear is accelerated to a target speed in the first phase,
in a second phase following the first phase, the opening width of the first hydraulic valve is reduced to a predetermined inflow opening width, and
the first hydraulic valve is closed during a return stroke that runs in the opposite direction to the working stroke.
